(19) United States
(12) Patent Application Publication
(10) Pub. No.: US 2025/0208403 A1
(43) Pub. Date: Jun. 26, 2025

(54) OCULAR OPTICAL SYSTEM AND MASS PRODUCTION MANUFACTURING METHOD THEREOF

(71) Applicant: GENIUS ELECTRONIC OPTICAL CO., LTD., Taichung City (TW)

(72) Inventors: Matthew Francis Bone, Taichung City (TW); Chun-Yang Huang, Taichung City (TW)

(73) Assignee: GENIUS ELECTRONIC OPTICAL CO., LTD., Taichung City (TW)

(21) Appl. No.: 18/393,717

(22) Filed: Dec. 22, 2023

(51) Int. Cl. G02B 25/00

(52) U.S. Cl. CPC G02B 25/001

(57) ABSTRACT

An ocular optical system, configuring to allow imaging rays from a display screen to enter an eye of an observer through the ocular optical system to form an image is provided. The ocular optical system comprises a first optical element and a second optical element sequentially arranged along an optical axis from an eye-side to a display-side, each of the first optical element and the second optical element comprising an eye-side surface and a display-side surface. The ocular optical system also comprises a reflective polarizing film and a quarter-wave plate, the eye-side surface of the first optical element and the display-side surface of the first optical element satisfy a conditional expression as follows: PV≤160 μm, wherein a PV is a peak to valley value of a surface. In addition, a mass production manufacturing method of the ocular optical system is also provided.

### BACKGROUND

### Field of the Invention

The disclosure relates to an optical system and a manufacturing method thereof, and in particular to an ocular optical system and mass production manufacturing method thereof.

### Description of Related Art

The optical systems for virtual reality (VR) applications currently available on the market can be primarily categorized into three types: aspherical optical elements, Fresnel optical elements, and pancake optical elements. The aspherical optical elements have the advantages of low manufacturing cost and less issues with flare and ghosting. However, they are heavy and have a large volume. The Fresnel optical elements are lighter, provide a partial improvement in the field of view, and have a manufacturing cost approximately twice that of aspherical optical elements. The drawback of the Fresnel optical elements is the more significant issue of glare. The pancake optical elements offer the advantage of being lighter and smaller than aspherical optical elements, with no glare problems. However, due to the optical film material cost being half of the lens cost and the higher difficulty in coating and assembly adjustments, the manufacturing cost is approximately 10 to 40 times that of aspherical optical elements, and there is a tendency for ghosting issues.

Due to the weight, volume, flare and ghosting, and manufacturing cost issues associated with the mainstream optical elements, VR has not become as widespread as smartphones. In addition to pursuing good image quality, users of VR systems also seek larger magnification ratios. Therefore, how the industry designs optical systems that have lower manufacturing costs, meet consumer demands for image quality, and offer larger magnification ratios is a challenge that needs to be addressed.

### SUMMARY

The invention provides an ocular optical system and mass production manufacturing method thereof with lower manufacturing costs and meets consumer demands for image quality and magnification ratio.

The disclosure provides an ocular optical system, configured to allow imaging rays from a display screen to enter an eye of an observer through the ocular optical system to form an image, wherein a side toward the eye is an eye-side, and a side toward the display screen is a display-side. The ocular optical system comprises a first optical element and a second optical element sequentially arranged along an optical axis from the eye-side to the display-side, each of the first optical element and the second optical element comprising an eye-side surface facing the eye-side and allowing the imaging rays to pass through and a display-side surface facing the display-side and allowing the imaging rays to pass through. The ocular optical system also comprises a reflective polarizing film and a quarter-wave plate. The eye-side surface of the first optical element and the display-side surface of the first optical element satisfy a conditional expression as follows: PV≤160 μm, wherein a PV is a peak to valley value of a surface. The reflective polarizing film is disposed on the eye-side of the first optical element. The quarter-wave plate is disposed on the display-side of the first optical element or between the reflective polarizing film and the eye-side of the first optical element. The ocular optical system satisfy a conditional expression as follows: 35|ObjD|/ImgH≤200, wherein ObjD is a distance from the eye of the observer to the image formed by the ocular optical system on the optical axis, and ImgH is a maximum image height of the ocular optical system.

The disclosure also provides an ocular optical system, configured to allow imaging rays from a display screen to enter an eye of an observer through the ocular optical system to form an image, wherein a side toward the eye is an eye-side, and a side toward the display screen is a display-side. The ocular optical system comprises a first optical element and a second optical element sequentially arranged along an optical axis from the eye-side to the display-side, each of the first optical element and the second optical element comprising an eye-side surface facing the eye-side and allowing the imaging rays to pass through and a display-side surface facing the display-side and allowing the imaging rays to pass through. The ocular optical system also comprises a reflective polarizing film and a quarter-wave plate. The eye-side surface of the first optical element, the display-side surface of the first optical element and the eye-side surface of the second optical element satisfy a conditional expression as follows: PV≤160 μm, wherein a PV is a peak to valley value of a surface. The reflective polarizing film is disposed on the eye-side of the first optical element. The quarter-wave plate is disposed on the display-side of the first optical element or between the reflective polarizing film and the eye-side of the first optical element. There is no air gap between the display-side surface of the first optical element and the eye-side surface of the second optical element.

The disclosure also provides a mass production manufacturing method of an ocular optical system, comprising: Manufacturing a large-size first optical element with low birefringence plastic or glass materials, wherein an eye-side surface of the large-size first optical element and a display-side surface of the large-size first optical element satisfy a conditional expression as follows: PV≤160 μm, wherein a PV is a peak to valley value of a surface; Disposing a large-size reflective polarizing film on the display-side surface of the large-size first optical element, and disposing a large-size quarter-wave plate on the display-side surface of the large-size first optical element or between the large-size reflective polarizing film and the display-side surface of the large-size first optical element to form optical films on the large-size first optical element; Combining a plurality of second optical elements to the display-side surface of the large-size first optical element with an adhesive which matches a refractive indices of large-size first optical element and refractive indices of the plurality of second optical elements to form a collection composed of a plurality of ocular optical systems arranged in an array; Cutting the collection composed of the plurality of ocular optical systems to form separated the plurality of the ocular optical systems.

Based on the above, the beneficial effects of the ocular optical system of an embodiment of the invention are: by satisfying the conditions of the optical design, the ocular optical system has lower manufacturing costs and meets consumer demands for image quality and magnification ratio.

In order to make the aforementioned features and advantages of the disclosure more comprehensible, embodiments accompanied with Figures are described in detail below.

### BRIEF DESCRIPTION OF THE DRAWINGS

FIG. 1 is a schematic view of imaging rays are emitted by a display screen and enter an eye via an ocular optical system.

FIG. 2 is a schematic diagram illustrating a surface shape structure of a lens element.

FIG. 3 is a schematic diagram illustrating a concave-convex structure and an intersection point of rays of a lens element.

FIG. 4 is a schematic diagram illustrating a surface shape structure of a lens element of Example 1.

FIG. 5 is a schematic diagram illustrating a surface shape structure of a lens element of Example 2.

FIG. 6 is a schematic diagram illustrating a surface shape structure of a lens element of Example 3.

FIG. 7 is a schematic diagram of an ocular optical system of a first embodiment of the invention.

FIG. 8A to FIG. 8D are diagrams of longitudinal spherical aberrations and various aberrations of an ocular optical system of the first embodiment.

FIG. 9 illustrates detailed optical data and aspheric parameters of an ocular optical system of the first embodiment of the invention.

FIG. 10 is a schematic diagram of an ocular optical system of a second embodiment of the invention.

FIG. 11A to FIG. 11D are diagrams of longitudinal spherical aberrations and various aberrations of an ocular optical system of the second embodiment.

FIG. 12 illustrates detailed optical data and aspheric parameters of an ocular optical system of the second embodiment of the invention.

FIG. 13 is a schematic diagram of an ocular optical system of a third embodiment of the invention.

FIG. 14A to FIG. 14D are diagrams of longitudinal spherical aberrations and various aberrations of an ocular optical system of the third embodiment.

FIG. 15 illustrates detailed optical data and aspheric parameters of an ocular optical system of the third embodiment of the invention.

FIG. 16 is a schematic diagram of an ocular optical system of a fourth embodiment of the invention.

FIG. 17A to FIG. 17D are diagrams of longitudinal spherical aberrations and various aberrations of an ocular optical system of the fourth embodiment.

FIG. 18 illustrates detailed optical data and aspheric parameters of an ocular optical system of the fourth embodiment of the invention.

FIG. 19 is a schematic diagram of an ocular optical system of a fifth embodiment of the invention.

FIG. 20A to FIG. 20D are diagrams of longitudinal spherical aberrations and various aberrations of an ocular optical system of the fifth embodiment.

FIG. 21 illustrates detailed optical data and aspheric parameters of an ocular optical system of the fifth embodiment of the invention.

FIG. 22 is a schematic diagram of an ocular optical system of a sixth embodiment of the invention.

FIG. 23A to FIG. 23D are diagrams of longitudinal spherical aberrations and various aberrations of an ocular optical system of the sixth embodiment.

FIG. 24 illustrates detailed optical data and aspheric parameters of an ocular optical system of the sixth embodiment of the invention.

FIG. 25 is a schematic diagram of an ocular optical system of a seventh embodiment of the invention.

FIG. 26A to FIG. 26D are diagrams of longitudinal spherical aberrations and various aberrations of an ocular optical system of the seventh embodiment.

FIG. 27 illustrates detailed optical data and aspheric parameters of an ocular optical system of the seventh embodiment of the invention.

FIG. 28 is a schematic diagram of an ocular optical system of an eighth embodiment of the invention.

FIG. 29A to FIG. 29D are diagrams of longitudinal spherical aberrations and various aberrations of an ocular optical system of the eighth embodiment.

FIG. 30 illustrates detailed optical data and aspheric parameters of an ocular optical system of the eighth embodiment of the invention.

FIG. 31 is a schematic diagram of an ocular optical system of a ninth embodiment of the invention.

FIG. 32A to FIG. 32D are diagrams of longitudinal spherical aberrations and various aberrations of an ocular optical system of the ninth embodiment.

FIG. 33 illustrates detailed optical data and aspheric parameters of an ocular optical system of the ninth embodiment of the invention.

FIG. 34 is a schematic diagram of an ocular optical system of a tenth embodiment of the invention.

FIG. 35A to FIG. 35D are diagrams of longitudinal spherical aberrations and various aberrations of an ocular optical system of the tenth embodiment.

FIG. 36 illustrates detailed optical data and aspheric parameters of an ocular optical system of the tenth embodiment of the invention.

FIG. 37 and FIG. 38 show the numerical values of the relationship formulas of various important parameters of the optical imaging lenses of the first to fifth embodiments of the invention.

FIG. 39 and FIG. 40 show the numerical values of the relationship formulas of various important parameters of the optical imaging lenses of the first to fifth embodiments of the invention.

FIG. 41 is a step flow chart of a mass production manufacturing method of an ocular optical system.

FIG. 42 is a schematic diagram of the mass production manufacturing method of the eyepiece optical system.

### DESCRIPTION OF THE EMBODIMENTS

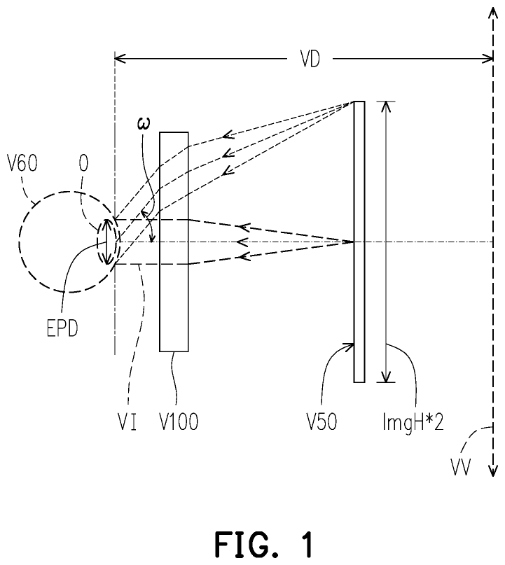

In general, a ray direction of an ocular optical system V100 refers to the following: imaging rays VI are emitted by a display screen V50, enter an eye V60 via the ocular optical system V100, and are then focused on a retina of the eye V60 for imaging and generating an enlarged virtual image VV at a least distance of distinct vision VD, as depicted in FIG. 1. The following criteria for determining optical specifications of the present application are based on assumption that a reversely tracking of the ray direction is parallel imaging rays passing through the ocular optical system from an eye-side and focused on the display screen for imaging.

The terms “optical axis region”, “periphery region”, “concave”, and “convex” used in this specification and claims should be interpreted based on the definition listed in the specification by the principle of lexicographer.

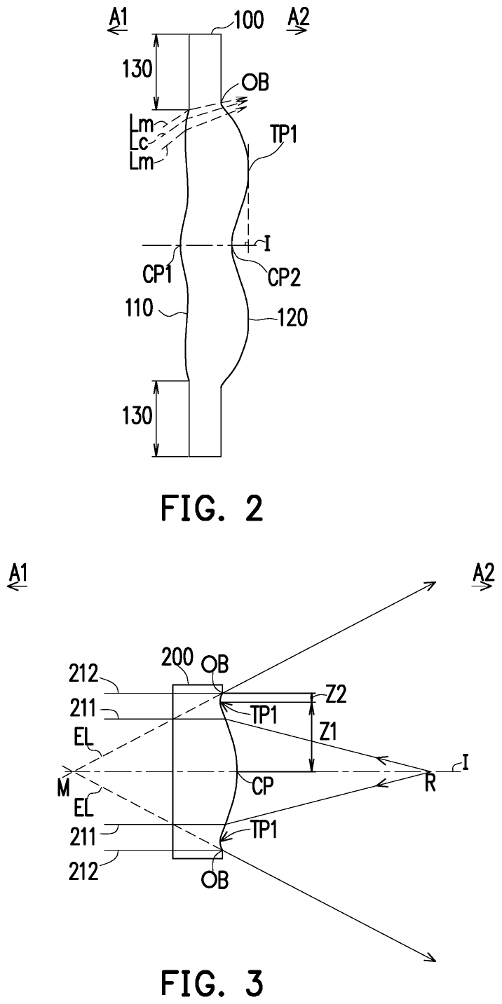

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an eye-side (or display-side) surface of a lens element” refers to a specific region of that surface of the lens element at which imaging rays can pass through that specific region. Imaging rays include at least two types of rays: a chief ray Lc and a marginal ray Lm (as shown in FIG. 2). An eye-side (or display-side) surface of a lens element can be characterized as having several regions, including an optical axis region, a periphery region, and, in some cases, one or more intermediate regions, as discussed more fully below.

FIG. 2 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 2, a first central point CP1 may be present on the eye-side surface 110 of lens element 100 and a second central point CP2 may be present on the display-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 5), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the display side A2 of the lens element. The shape of a region is concave if the extension line of a collimated ray being parallel to the optical axis I and passing through the region intersects the optical axis I on the eye side A1 of the lens element.

Additionally, referring to FIG. 2, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 3, optical axis region Z1 is defined between central point CP and first transition point TP1. Periphery region Z2 is defined between TP1 and the optical boundary OB of the surface of the lens element. Collimated ray 211 intersects the optical axis I on the display side A2 of lens element 200 after passing through optical axis region Z1, i.e., the focal point of collimated ray 211 after passing through optical axis region Z1 is on the display side A2 of the lens element 200 at point R in FIG. 3. Accordingly, since the ray itself intersects the optical axis I on the display side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the eye side A1 of lens element 200, i.e., the focal point of collimated ray 212 after passing through periphery region Z2 is on the eye side A1 at point M in FIG. 3. Accordingly, since the extension line EL of the ray intersects the optical axis I on the eye side A1 of the lens element 200, periphery region Z2 is concave. In the lens element 200 illustrated in FIG. 3, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an eye-side surface, a positive R value defines that the optical axis region of the eye-side surface is convex, and a negative R value defines that the optical axis region of the eye-side surface is concave. Conversely, for a display-side surface, a positive R value defines that the optical axis region of the display-side surface is concave, and a negative R value defines that the optical axis region of the display-side surface is convex. The result found by using this method should be consistent with the method utilizing intersection of the optical axis by rays/extension lines mentioned above, which determines surface shape by referring to whether the focal point of a collimated ray being parallel to the optical axis I is on the eye-side or the display-side of a lens element. As used herein, the terms “a shape of a region is convex (concave),” “a region is convex (concave),” and “a convex-(concave-) region,” can be used alternatively.

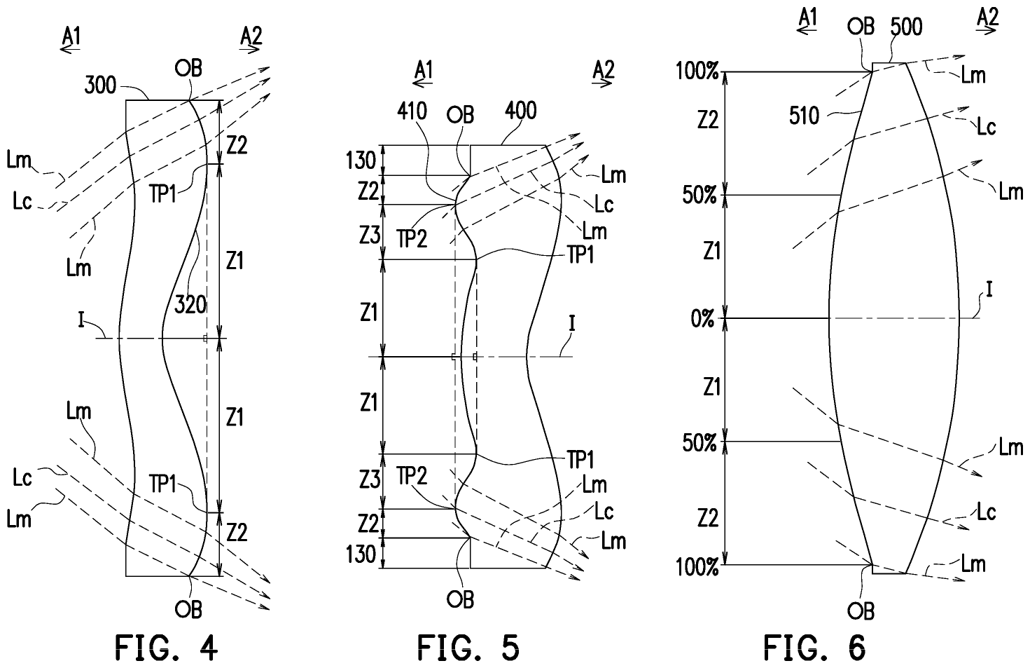

FIG. 4, FIG. 5 and FIG. 6 illustrate examples of determining the shape of lens element regions and the boundaries of regions under various circumstances, including the optical axis region, the periphery region, and intermediate regions as set forth in the present specification.

FIG. 4 is a radial cross-sectional view of a lens element 300. As illustrated in FIG. 4, only one transition point TP1 appears within the optical boundary OB of the display-side surface 320 of the lens element 300. Optical axis region Z1 and periphery region Z2 of the display-side surface 320 of lens element 300 are illustrated. The R value of the display-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 4, since the shape of the optical axis region Z1 is concave, the shape of the periphery region Z2 will be convex as the shape changes at the transition point TP1.

FIG. 5 is a radial cross-sectional view of a lens element 400. Referring to FIG. 5, a first transition point TP1 and a second transition point TP2 are present on the eye-side surface 410 of lens element 400. The optical axis region Z1 of the eye-side surface 410 is defined between the optical axis I and the first transition point TP1. The R value of the eye-side surface 410 is positive (i.e., R>0). Accordingly, the optical axis region Z1 is convex.

The periphery region Z2 of the eye-side surface 410, which is also convex, is defined between the second transition point TP2 and the optical boundary OB of the eye-side surface 410 of the lens element 400. Further, intermediate region Z3 of the eye-side surface 410, which is concave, is defined between the first transition point TP1 and the second transition point TP2. Referring once again to FIG. 5, the eye-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the eye-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 6 is a radial cross-sectional view of a lens element 500. Lens element 500 has no transition point on the eye-side surface 510 of the lens element 500. For a surface of a lens element with no transition point, for example, the eye-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 6, the optical axis region Z1 of the eye-side surface 510 is defined between the optical axis I and 50% of the distance between the optical axis I and the optical boundary OB. The R value of the eye-side surface 510 is positive (i.e., R>0). Accordingly, the optical axis region Z1 is convex. For the eye-side surface 510 of the lens element 500, because there is no transition point, the periphery region Z2 of the eye-side surface 510 is also convex. It should be noted that lens element 500 may have a mounting portion (not shown) extending radially outward from the periphery region Z2.

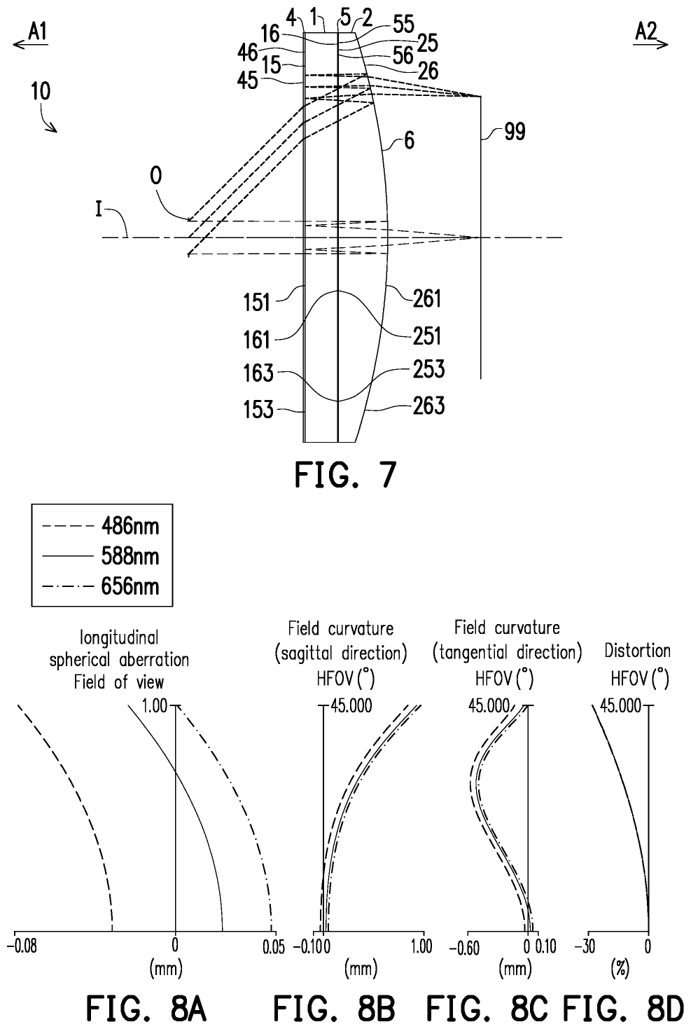

FIG. 7 is a schematic of the ocular optical system of the first embodiment of the invention. FIG. 8A to FIG. 8D are diagrams of the longitudinal spherical aberration and various aberrations of the ocular optical system of the first embodiment. Referring to FIG. 7 first, an ocular optical system 10 of the first embodiment of the invention sequentially includes a linear polarizing film plus reflective polarizing film 4, a first optical element 1, a quarter-wave plate 5 and a second optical element 2 along an optical axis I of the ocular optical system 10 from an eye-side A1 to a display-side A2. When imaging rays emitted by a display screen (shown as display screen 99 in FIG. 7) to be photographed passes through the ocular optical system 10 and enters an eye (shown as pupil 0 of observer in FIG. 7) of an observer to form an image, and the image is a magnify virtual image.

In the present embodiment, the first optical element 1, the second optical element 2, the linear polarizing film plus reflective polarizing film 4 and the quarter-wave plate 5 each have an eye-side surface 15, 25, 45 and 55 facing the eye-side A1 and allowing the imaging rays to pass through and a display-side surface 16, 26, 46 and 56 facing the display-side A2 and allowing the imaging rays to pass through. In the present embodiment, the first optical element 1 is placed between the pupil 0 of observer and the second optical element 2. In addition, the display-side surface 26 of the second optical element 2 includes a partially reflective mirror 6, adapted to reflect half the energy of imaging rays. The partially reflective mirror 6 has an average optical reflectance of at least 30% in a desired plurality of wavelengths, and the partially reflective mirror 6 is a half mirror in the present embodiment.

The first optical element 1 is a flat plate. An optical axis region 151 of the eye-side surface 15 of the first optical element 1 is flat, and a periphery region 153 thereof is flat. An optical axis region 161 of the display-side surface 16 of the first optical element 1 is flat, and a periphery region 163 thereof is flat.

The second optical element 2 is a lens element and has positive refracting power. An optical axis region 251 of the eye-side surface 25 of the second optical element 2 is flat, and a periphery region 253 thereof is flat. An optical axis region 261 of the display-side surface 26 of the second optical element 2 is convex, and a periphery region 263 thereof is convex. In the present embodiment, the eye-side surface 25 and the display-side surface 26 of the second optical element 2 are both aspheric surfaces, but the invention is not limited thereto. The peak to valley value (PV) of the eye-side surface 15 of the first optical element 1, the display-side surface 16 of the first optical element 1 and the eye-side surface 25 of the second optical element satisfy PV=0 μm. However, in reality, the PV will be subject to the tolerance generated during the manufacturing process, resulting in PV≤5 μm.

The reflective polarizing film is disposed on the eye-side A1 of the first optical element 1, adapted to reflect imaging rays with one state of linearly polarized and allow the imaging rays with another state of linearly polarized to pass through. In particular, the linear polarizing film plus reflective polarizing film 4 is disposed on the eye-side surface 15 of the first optical element 1.

The quarter-wave plate 5 is disposed on the display-side A2 of the first optical element 1 or between the linear polarizing film plus reflective polarizing film 4 and the eye-side A1 of the first optical element 1, adapted to convert imaging rays with circularly polarized into imaging rays with linearly polarized, or convert imaging rays with linearly polarized into imaging rays with circularly polarized state. In particular, the quarter-wave plate 5 is disposed between the display-side surface 16 of the first optical element 1 and the eye-side surface 25 of the second optical element 2.

In detail, in the present embodiment, the display screen (shown as display screen 99 in FIG. 7) provides imaging rays with a one state of circularly polarized and passed through the second optical element 2 to the quarter-wave plate 5 to form imaging rays with a one state of linearly polarized. The imaging rays with the one state of linearly polarized passed through the first optical element 1 to the reflective polarizing film to reflect imaging rays with the one state of linearly polarized. The imaging rays with the one state of linearly polarized passed through the first optical element 1 and the quarter-wave plate 5 again to form imaging rays with another one state of circularly polarized. The imaging rays with the another one state of circularly polarized passed through the second optical element 2 to the display-side surface 26 of the second optical element 2 which includes a partially reflective mirror 6 to reflect imaging rays with the another one state of circularly polarized. The imaging rays with the another one state of circularly polarized passed through the second optical element 2 to the quarter-wave plate 5 again to form imaging rays with another one state of linearly polarized. Final, the imaging rays with the another one state of linearly polarized passed through the first optical element 1 and the linear polarizing film plus reflective polarizing film 4, then enter an eye (shown as pupil 0 of observer in FIG. 7) of an observer to form an image.

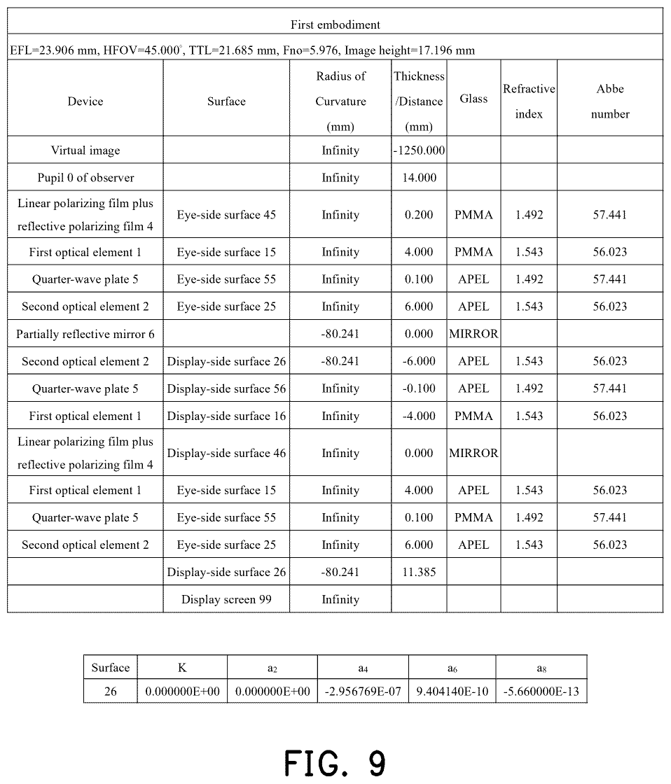

Other detailed optical data of the first embodiment is shown in FIG. 9, and the ocular optical system 10 of the first embodiment has an effective focal length (EFL) of 23.906 millimeters (mm), a half field of view (HFOV) of 45.000 degrees, a TTL of 21.685 mm, an f-number (Fno) of 5.976, and an image height of 17.196 mm, wherein the TTL refers to the distance from the eye-side surface 15 of the first optical element 1 to the display screen 99 on the optical axis I.

Moreover, in the present embodiment, the display-side surface 26 of the second optical element 2 is an aspherical surface, wherein the display-side surface 26 are even aspheric surfaces. The aspheric surface is defined according to the following general formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

Wherein:
R: radius of curvature of the lens element surface near the optical axis I;
Z: depth of aspheric surface (vertical distance between the point on the aspheric surface for which the distance from the optical axis I is Y and the cross section tangent to the vertex on the aspheric surface optical axis I);
Y: vertical distance between a point on the aspheric surface curve and the optical axis I;
K: conic constant;
aᵢ: i-th aspheric surface coefficient.

The aspheric coefficients of the display-side surface 26 of the second optical element 2 in general formula (1) is as shown in FIG. 9. In particular, field number 26 in FIG. 9 represents the aspheric coefficient of the display-side surface 26 of the second optical element 2. In the present embodiment and the following embodiments, the second-order aspheric coefficients a₂ is zero.

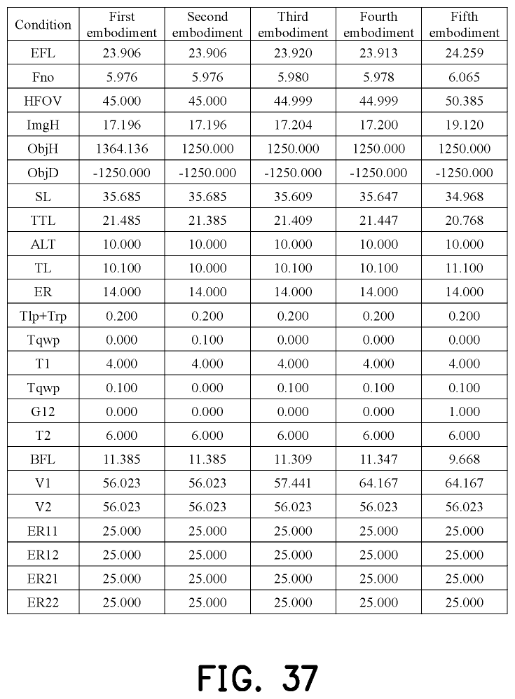

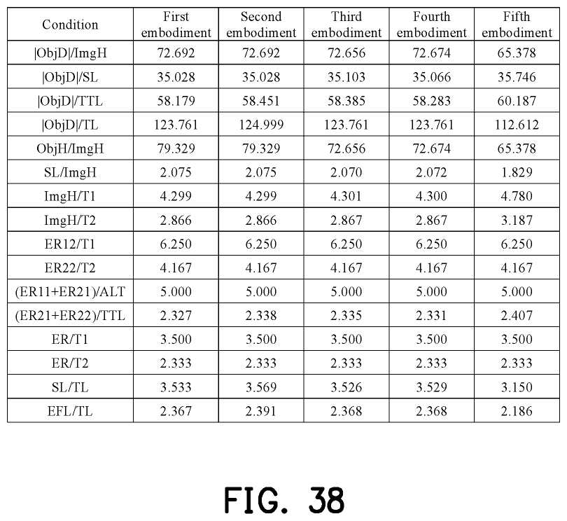

Moreover, the relationship between each of the important parameters in the ocular optical system 10 of the first embodiment is as shown in FIG. 37 and FIG. 38.

In particular,
EPD is the exit pupil diameter of the optical imaging lens 10, corresponding to the diameter of pupil of the observer;
ER is the eye relief, the distance from the eye of the observer to the first optical element 1 on the optical axis I;
ER11 is the maximum distance from the center of the eye-side surface 15 of the first optical element 1 to the mounting portion;
ER12 is the maximum distance from the center of the display-side surface 16 of the first optical element 1 to the mounting portion;
ER21 is the maximum distance from the center of the eye-side surface 25 of the second optical element 2 to the mounting portion;
ER22 is the maximum distance from the center of the display-side surface 26 of the second optical element 2 to the mounting portion;
PV is a peak to valley value of a surface, in other words, is the difference between the highest point and the lowest point on a surface;
ω is the half field of view, the maximum angle of the half field of view of the observer;
ObjH is the maximum height of the image formed by the ocular optical system 10, wherein the image is a virtual image;
ObjD is the distance from the eye of the observer to the image formed by the ocular optical system 10 on the optical axis I;
T1 is the thickness of the first optical element 1 on the optical axis I;
T2 is the thickness of the second optical element 2 on the optical axis I;
T3 is the thickness of the third optical element 3 on the optical axis I;
Tlp+Trp is the sum of thicknesses of the linear polarizing film and reflective polarizing film on the optical axis I;
Tqwp is the thickness of the quarter-wave plate 5 on the optical axis I;
Toca is the thickness of the optical clear adhesive 7 on the optical axis I;
G12 is the air gap 7 from the first lens element 1 to the second lens element 2 on the optical axis I;
BFL is the distance from the display-side surface 26 of the second optical element 2 to the display screen on the optical axis I;
ImgH is the maximum image height of the ocular optical system 10, that is half of the image circle diameter;
ALT is the sum of thicknesses of the first optical element 1 and the second optical element 2 on the optical axis I;
TL is the distance from the eye-side surface of the optical element closest to the eye-side A1 to the display-side surface 26 of the second optical element 2 on the optical axis I;
TTL is the distance from the eye-side surface of the optical element closest to the eye-side A1 to the display screen A2 on the optical axis I;
SL is the system length of the ocular optical system 10, the distance from the eye of the observer to the display screen on the optical axis I;
EFL is the effective focal length of the ocular optical system 10.

Moreover, the following are further defined:
f1 is the focal length of the first optical element 1;
f2 is the focal length of the second optical element 2;
f3 is the focal length of the third optical element 3;
Nd1 is the refractive index of the first optical element 1;
Nd2 is the refractive index of the second optical element 2;
Nd3 is the refractive index of the third optical element 3;
V1 is the Abbe number of the first optical element 1;
V2 is the Abbe number of the second optical element 2;
V3 is the Abbe number of the third optical element 3.

Referring further to FIG. 8A to FIG. 8D, FIG. 8A illustrates the longitudinal spherical aberration on the display screen 99 when the wavelengths of the first embodiment are 486 nm, 588 nm, and 656 nm, FIG. 8B and FIG. 8C respectively illustrate the field curvature aberration in the sagittal direction and the field curvature aberration in the tangential direction on the display screen 99 when the wavelengths of the first embodiment are 486 nm, 588 nm, and 656 nm, and FIG. 8D illustrates the distortion aberration on the display screen 99 when the wavelengths of the first embodiment are 486 nm, 588 nm, and 656 nm. The longitudinal spherical aberration of the first embodiment is shown in FIG. 8A, wherein the curves formed by various wavelengths are all very close and are near the center, indicating the off-axis rays at different heights of each wavelength are all concentrated near the imaging point, and it may be seen from the deflection amplitude of the curve of each wavelength that, the imaging point deviation of the off-axis rays at different heights is controlled within the range of ±0.08 mm, and therefore in the present first embodiment, the spherical aberration of the same wavelength is indeed significantly alleviated. Moreover, the distances between the three representative wavelengths are also relatively close, indicating the imaging positions of different wavelength rays are relatively concentrated, and therefore the chromatic aberration is also significantly alleviated.

In the two field curvature aberration diagrams of FIG. 8B and FIG. 8C, the focal length variations of the three representative wavelengths in the entire field of view is within ±1.00 mm, indicating that the optical system of the first embodiment may effectively eliminate aberrations. The distortion aberration diagram of FIG. 8D shows that the distortion aberration of the present embodiment is maintained within the range of ±30%, indicating that the distortion aberration of the first embodiment meets the imaging quality requirements of the optical system. Accordingly, compared with the existing optical lens, the present first embodiment may still provide good imaging quality under the condition that the TTL is shortened to 21.685 mm. Therefore, the first embodiment may have a larger aperture, a larger image height, excellent imaging quality, lower manufacturing costs under the condition of maintaining good optical performance.

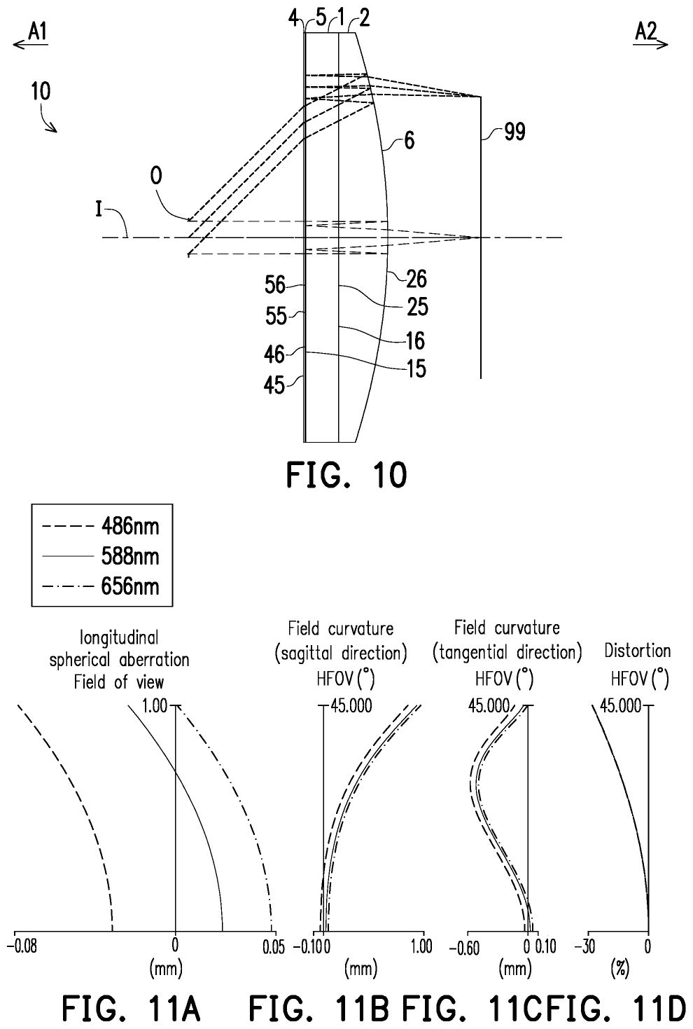

FIG. 10 is a schematic of the optical imaging lens of the second embodiment of the invention. FIG. 11A to FIG. 11D are diagrams of the longitudinal spherical aberration and various aberrations of the optical imaging lens of the second embodiment. Referring first to FIG. 10, the second embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the linear polarizing film plus reflective polarizing film 4 is modified and disposed on the quarter-wave plate 5, which can facilitate the stacking of three optical films. It should be mentioned here that, to clearly show the Figure, in FIG. 10, the reference numerals of the optical axis region and the periphery region similar to the surface shape in the first embodiment are omitted.

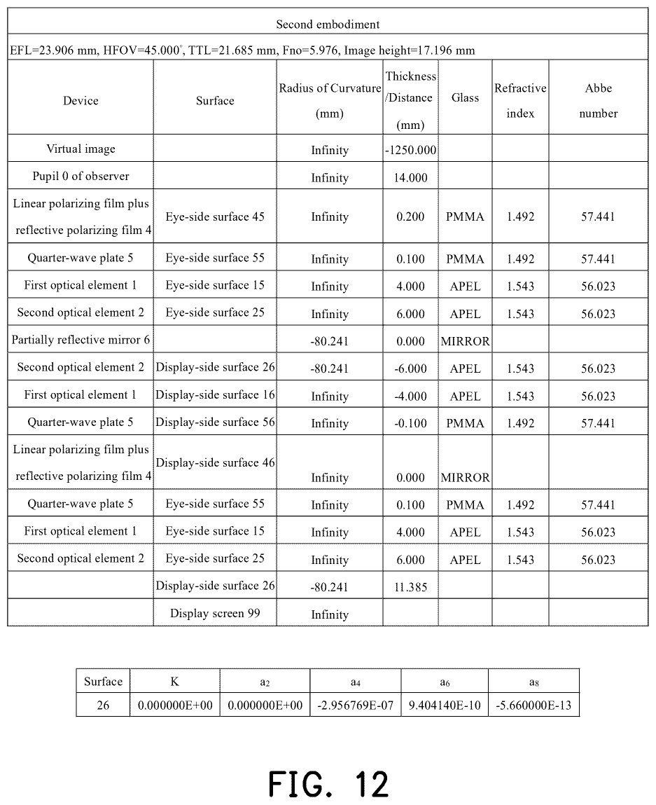

The detailed optical data of the ocular optical system 10 of the second embodiment is shown in FIG. 12, and the ocular optical system 10 of the second embodiment has an effective focal length of 23.906 mm, a half field of view of 45.000 degrees, a TTL of 21.685 mm, an f-number of 5.976, and an image height of 17.196 mm.

FIG. 12 also shows the aspheric coefficients of the display-side surface 26 of the second optical element 2 of the second embodiment in general formula (1).

Moreover, the relationship between each of the important parameters in the ocular optical system 10 of the second embodiment is as shown in FIG. 37 and FIG. 38.

FIG. 11A illustrates the longitudinal spherical aberration of the second embodiment, in which the imaging point deviation of off-axis rays at different heights is controlled within the range of ±0.08 mm. In the two field curvature aberration diagrams of FIG. 11B and FIG. 11C, the focal length variation amount of the three representative wavelengths in the entire field of view is within ±1.00 mm. The distortion aberration diagram of FIG. 11D shows that the distortion aberration of the present embodiment is maintained within the range of ±30%.

It may be known from the above description that the second embodiment is easy to manufacture. Therefore, compared with the first embodiment, the second embodiment has a higher yield.

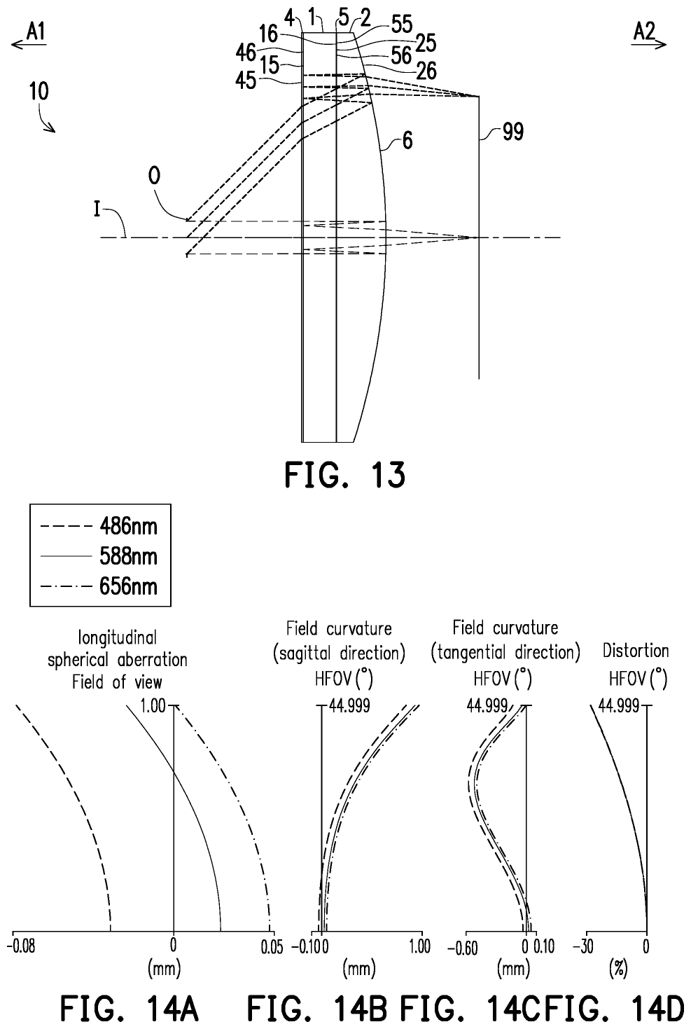

FIG. 13 is a schematic of the optical imaging lens of the third embodiment of the invention. FIG. 14A to FIG. 14D are diagrams of the longitudinal spherical aberration and various aberrations of the optical imaging lens of the third embodiment. Referring first to FIG. 13, the third embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the material of the first optical element 1 was replaced with other low birefringence plastic, which facilitates the use of low-stress optical plastic materials to reduce the occurrence of ghosting. It should be mentioned here that, to clearly show the Figure, in FIG. 13, the reference numerals of the optical axis region and the periphery region similar to the surface shape in the first embodiment are omitted.

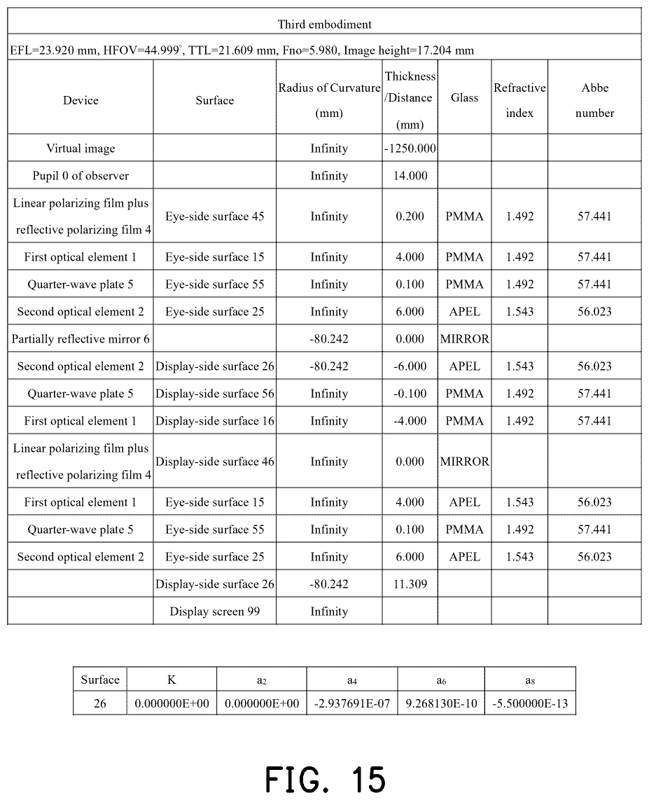

The detailed optical data of the ocular optical system 10 of the third embodiment is shown in FIG. 15, and the ocular optical system 10 of the third embodiment has an effective focal length of 23.920 mm, a half field of view of 44.999 degrees, a TTL of 21.609 mm, an f-number of 5.980, and an image height of 17.204 mm.

FIG. 15 also shows the aspheric coefficients of the display-side surface 26 of the second optical element 2 of the third embodiment in general formula (1).

Moreover, the relationship between each of the important parameters in the ocular optical system 10 of the third embodiment is as shown in FIG. 37 and FIG. 38.

FIG. 14A illustrates the longitudinal spherical aberration of the third embodiment, in which the imaging point deviation of off-axis rays at different heights is controlled within the range of ±0.08 mm. In the two field curvature aberration diagrams of FIG. 14B and FIG. 14C, the focal length variation amount of the three representative wavelengths in the entire field of view is within ±1.00 mm. The distortion aberration diagram of FIG. 14D shows that the distortion aberration of the present embodiment is maintained within the range of ±30%.

It may be known from the above description that the TTL of the third embodiment is shorter than the TTL of the first embodiment. Therefore, compared with the first embodiment, the third embodiment has a smaller volume. The image height of the third embodiment is larger than the image height of the first embodiment. Therefore, compared with the first embodiment, the third embodiment has better optical sensitivity.

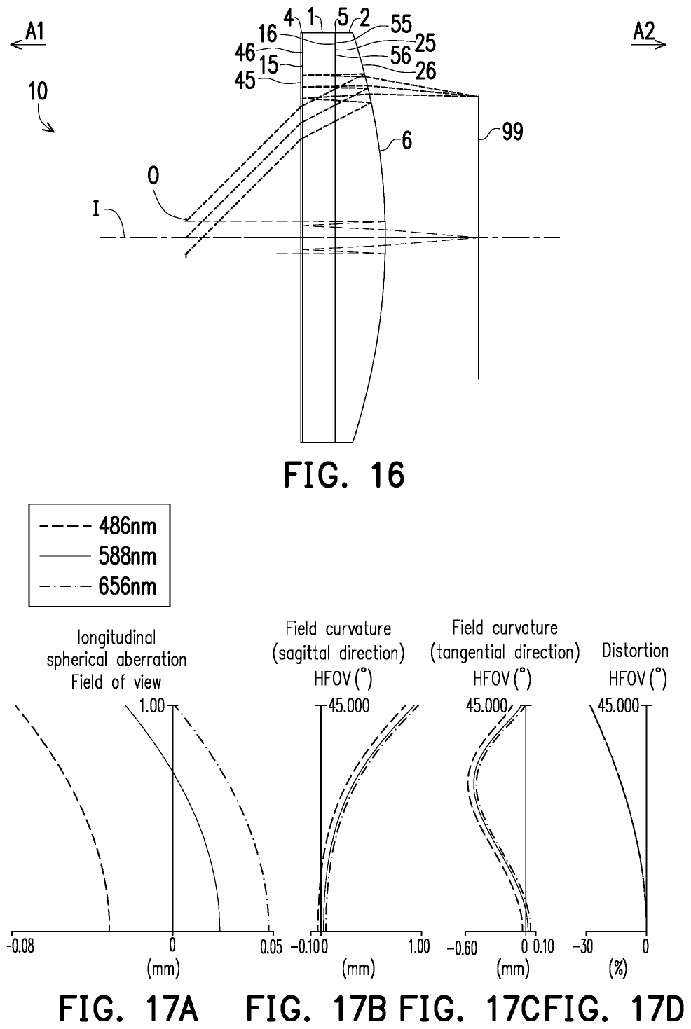

FIG. 16 is a schematic of the optical imaging lens of the fourth embodiment of the invention. FIG. 17A to FIG. 17D are diagrams of the longitudinal spherical aberration and various aberrations of the optical imaging lens of the fourth embodiment. Referring first to FIG. 16, the fourth embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the material was replaced with low birefringence glass, which facilitates the use of low-stress optical glass materials to reduce the occurrence of ghosting. It should be mentioned here that, to clearly show the Figure, in FIG. 16, the reference numerals of the optical axis region and the periphery region similar to the surface shape in the first embodiment are omitted.

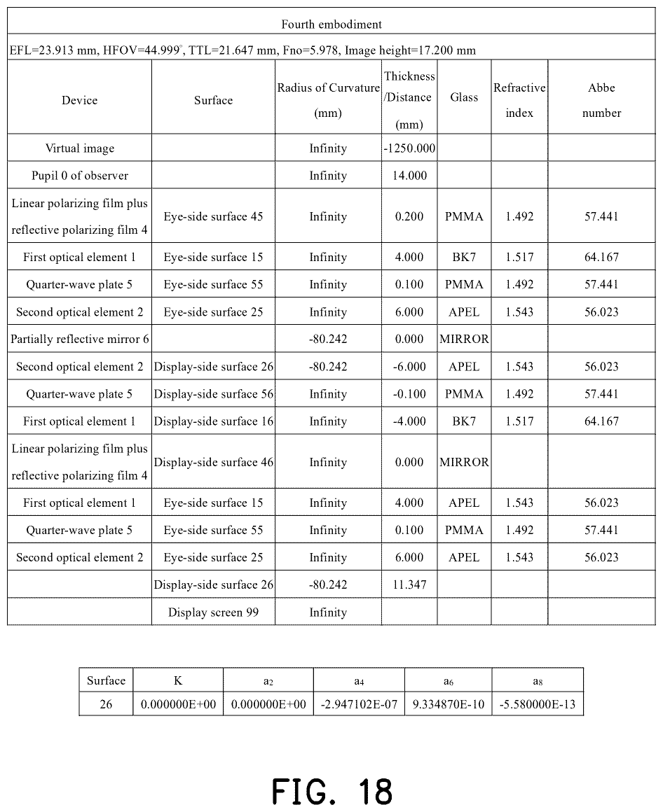

The detailed optical data of the ocular optical system 10 of the fourth embodiment is shown in FIG. 18, and the ocular optical system 10 of the fourth embodiment has an effective focal length of 23.913 mm, a half field of view of 44.999 degrees, a TTL of 21.647 mm, an f-number of 5.978, and an image height of 17.200 mm.

FIG. 18 also shows the aspheric coefficients of the display-side surface 26 of the second optical element 2 of the fourth embodiment in general formula (1).

Moreover, the relationship between each of the important parameters in the ocular optical system 10 of the fourth embodiment is as shown in FIG. 37 and FIG. 38.

FIG. 17A illustrates the longitudinal spherical aberration of the fourth embodiment, in which the imaging point deviation of off-axis rays at different heights is controlled within the range of ±0.08 mm. In the two field curvature aberration diagrams of FIG. 17B and FIG. 17C, the focal length variation amount of the three representative wavelengths in the entire field of view is within ±1.00 mm. The distortion aberration diagram of FIG. 17D shows that the distortion aberration of the present embodiment is maintained within the range of ±30%.

It may be known from the above description that the TTL of the fourth embodiment is shorter than the TTL of the first embodiment. Therefore, compared with the first embodiment, the fourth embodiment has a smaller volume. The image height of the fourth embodiment is larger than the image height of the first embodiment. Therefore, compared with the first embodiment, the fourth embodiment has better optical sensitivity.

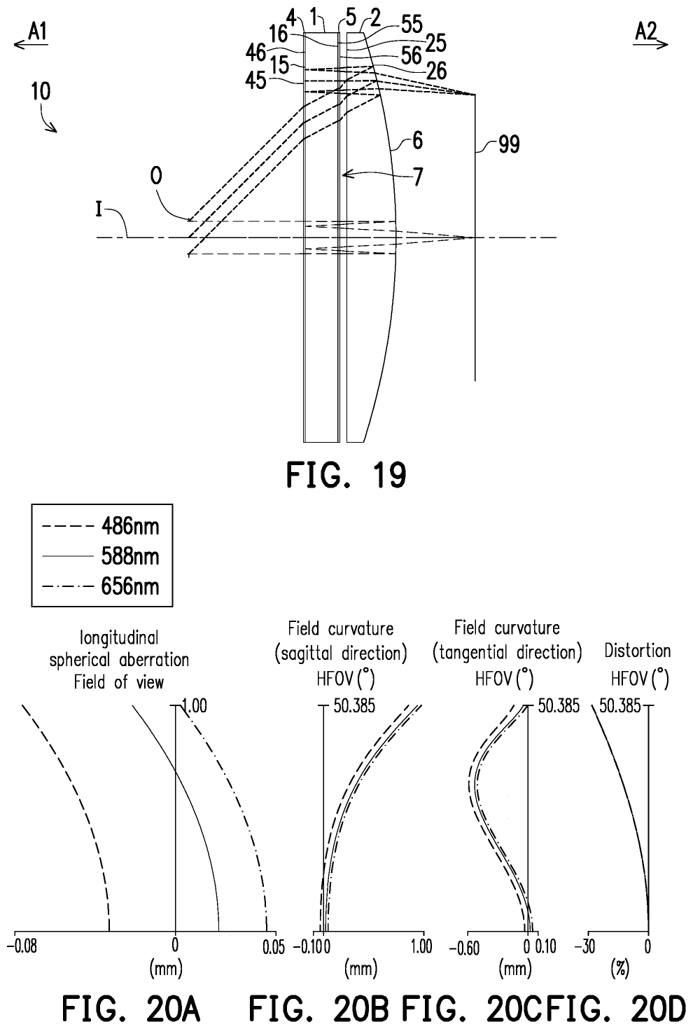

FIG. 19 is a schematic of the optical imaging lens of the fifth embodiment of the invention. FIG. 20A to FIG. 20D are diagrams of the longitudinal spherical aberration and various aberrations of the optical imaging lens of the fifth embodiment. Referring first to FIG. 19, the fifth embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the anti-reflective film is designed on the display-side surface 16 of the first optical element 1 and the eye-side surface 25 of the second optical element 2, which can help reduce the chance of ghosting. In addition, there is an air gap 7 between the first optical element 1 and the second optical element 2, which can help reduce TTL and reduce the difficulty of the bonding process between the first optical element 1 and the second optical element 2. It should be mentioned here that, to clearly show the Figure, in FIG. 19, the reference numerals of the optical axis region and the periphery region similar to the surface shape in the first embodiment are omitted.

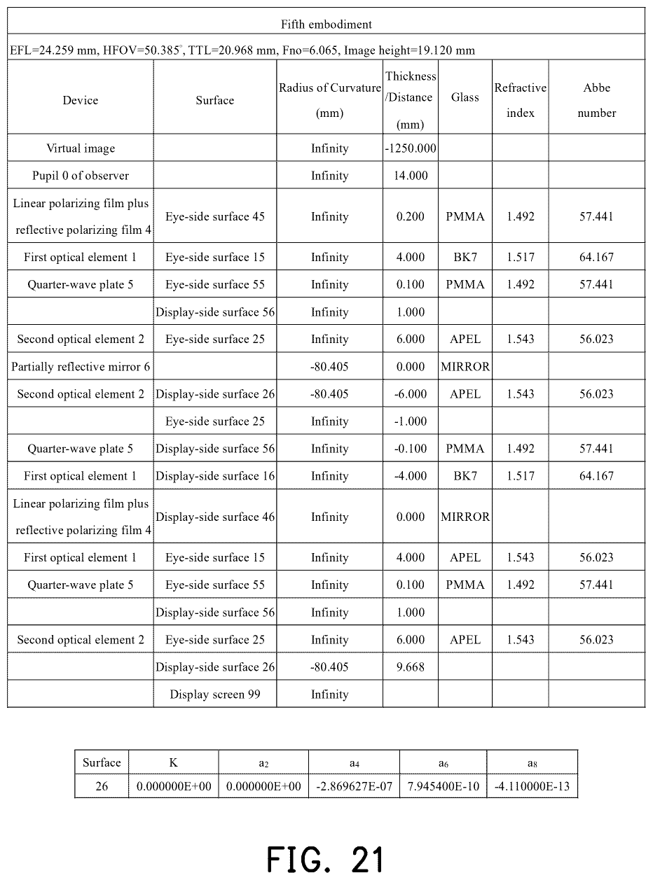

The detailed optical data of the ocular optical system 10 of the fifth embodiment is shown in FIG. 21, and the ocular optical system 10 of the fifth embodiment has an effective focal length of 24.259 mm, a half field of view of 50.385 degrees, a TTL of 20.968 mm, an f-number of 6.065, and an image height of 19.120 mm.

FIG. 21 also shows the aspheric coefficients of the display-side surface 26 of the second optical element 2 of the fifth embodiment in general formula (1).

Moreover, the relationship between each of the important parameters in the ocular optical system 10 of the fifth embodiment is as shown in FIG. 37 and FIG. 38.

FIG. 20A illustrates the longitudinal spherical aberration of the fifth embodiment, in which the imaging point deviation of off-axis rays at different heights is controlled within the range of ±0.08 mm. In the two field curvature aberration diagrams of FIG. 20B and FIG. 20C, the focal length variation amount of the three representative wavelengths in the entire field of view is within ±1.00 mm. The distortion aberration diagram of FIG. 20D shows that the distortion aberration of the present embodiment is maintained within the range of ±30%.

It may be known from the above description that the half field of view of the fifth embodiment is larger than the half field of view of the first embodiment. Therefore, compared with the first embodiment, the fifth embodiment has a larger angular range for receiving an image. The TTL of the fifth embodiment is shorter than the TTL of the first embodiment. Therefore, compared with the first embodiment, the fifth embodiment has a smaller volume. The image height of the fifth embodiment is larger than the image height of the first embodiment. Therefore, compared with the first embodiment, the fifth embodiment has better optical sensitivity.

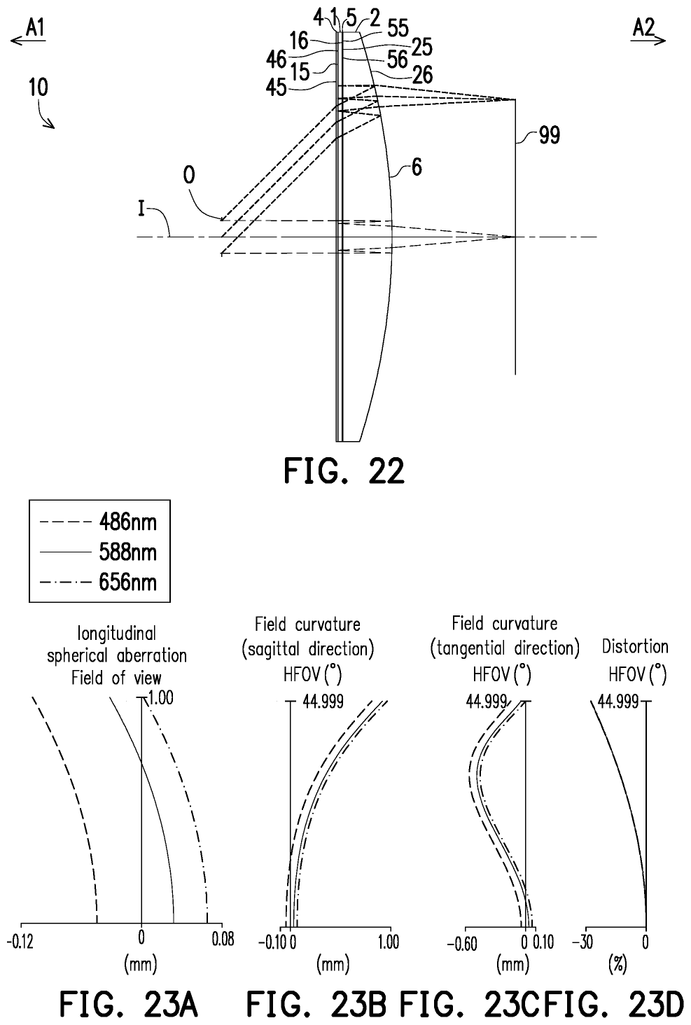

FIG. 22 is a schematic of the optical imaging lens of the sixth embodiment of the invention. FIG. 23A to FIG. 23D are diagrams of the longitudinal spherical aberration and various aberrations of the optical imaging lens of the sixth embodiment. Referring first to FIG. 22, the sixth embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the thickness of the first optical element 1 is shortened, which can help reduce the weight of the ocular optical system 10 and shorten the injection molding time of the first optical element 1 to increase production capacity. It should be mentioned here that, to clearly show the Figure, in FIG. 22, the reference numerals of the optical axis region and the periphery region similar to the surface shape in the first embodiment are omitted.

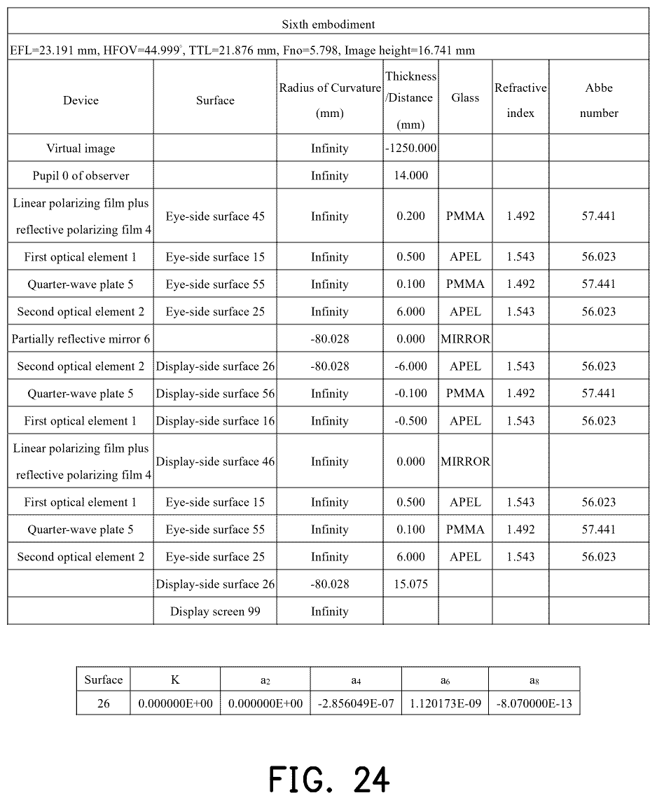

The detailed optical data of the ocular optical system 10 of the sixth embodiment is shown in FIG. 24, and the ocular optical system 10 of the sixth embodiment has an effective focal length of 23.191 mm, a half field of view of 44.999 degrees, a TTL of 21.876 mm, an f-number of 5.798, and an image height of 16.741 mm.

FIG. 24 also shows the aspheric coefficients of the display-side surface 26 of the second optical element 2 of the sixth embodiment in general formula (1).

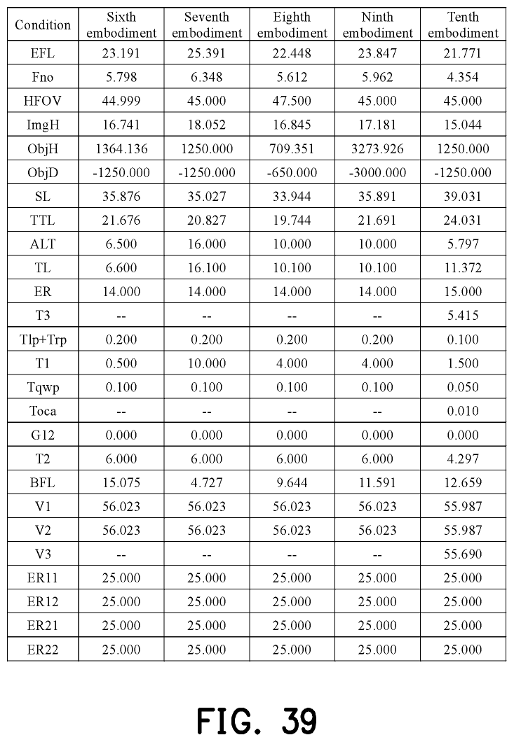

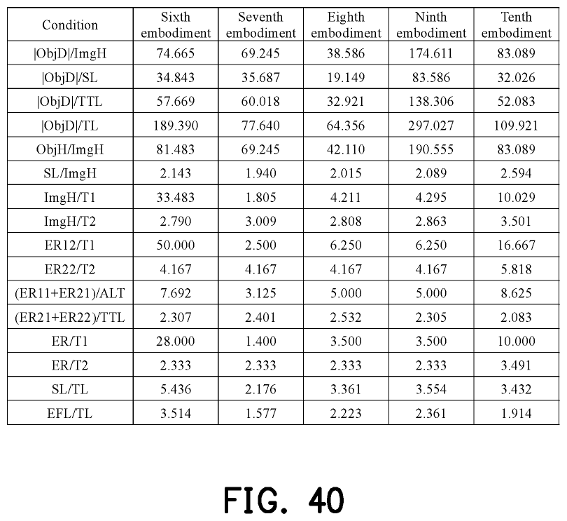

Moreover, the relationship between each of the important parameters in the ocular optical system 10 of the sixth embodiment is as shown in FIG. 39 and FIG. 40.

FIG. 23A illustrates the longitudinal spherical aberration of the sixth embodiment, in which the imaging point deviation of off-axis rays at different heights is controlled within the range of ±0.12 mm. In the two field curvature aberration diagrams of FIG. 23B and FIG. 23C, the focal length variation amount of the three representative wavelengths in the entire field of view is within ±1.00 mm. The distortion aberration diagram of FIG. 23D shows that the distortion aberration of the present embodiment is maintained within the range of ±30%.

It may be known from the above description that the aperture of the sixth embodiment is larger than the aperture of the first embodiment. Therefore, compared with the first embodiment, the sixth embodiment has a larger light influx.

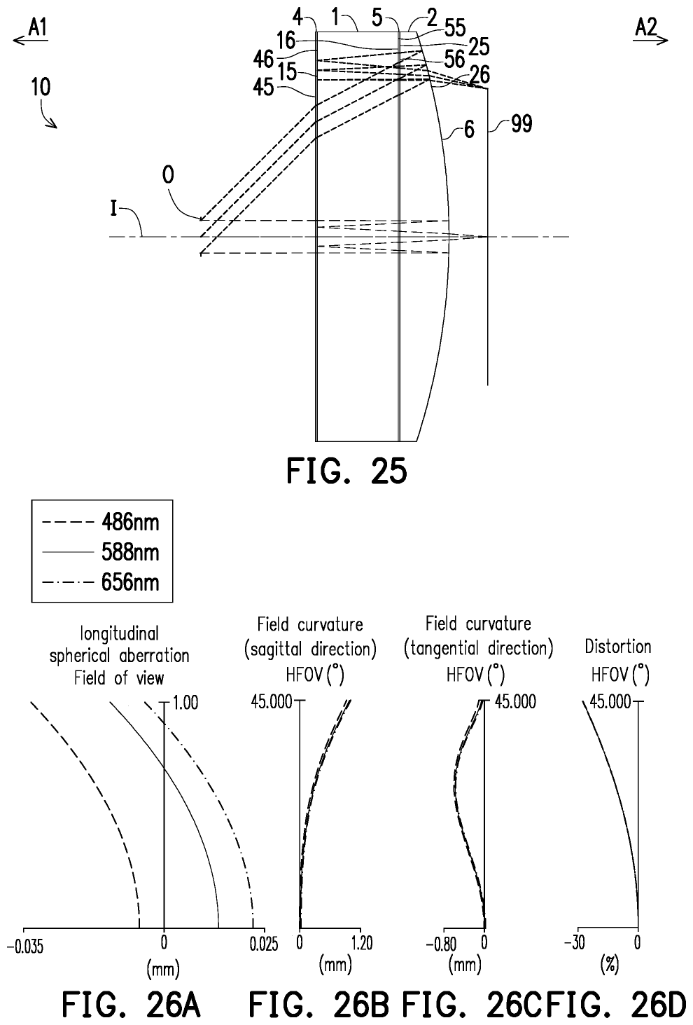

FIG. 25 is a schematic of the optical imaging lens of the seventh embodiment of the invention. FIG. 26A to FIG. 26D are diagrams of the longitudinal spherical aberration and various aberrations of the optical imaging lens of the seventh embodiment. Referring first to FIG. 25, the seventh embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the thickness of the first optical element 1 is increased, which can help shorten the TTL of the ocular optical system 10. It should be mentioned here that, to clearly show the Figure, in FIG. 25, the reference numerals of the optical axis region and the periphery region similar to the surface shape in the first embodiment are omitted.

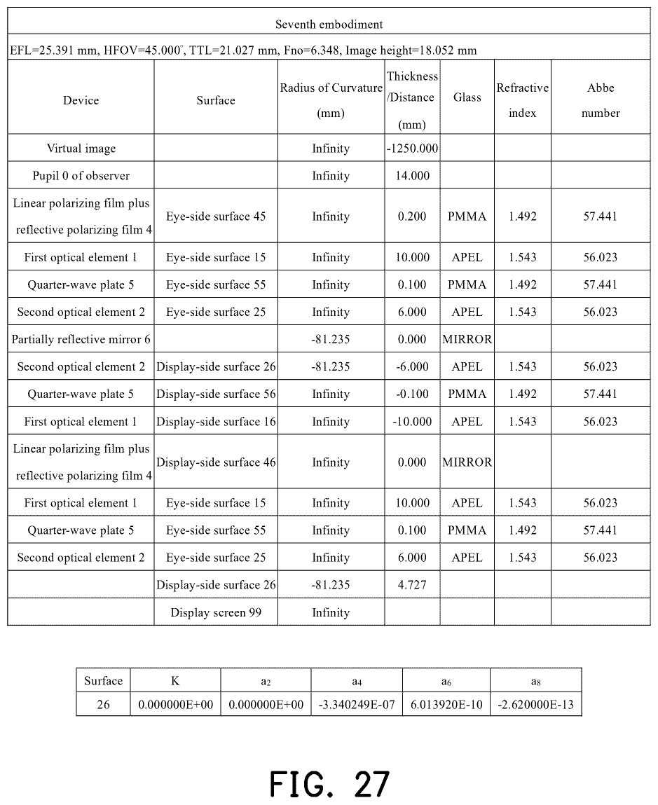

The detailed optical data of the ocular optical system 10 of the seventh embodiment is shown in FIG. 27, and the ocular optical system 10 of the seventh embodiment has an effective focal length of 25.391 mm, a half field of view of 45.000 degrees, a TTL of 21.027 mm, an f-number of 6.348, and an image height of 18.052 mm.

FIG. 27 also shows the aspheric coefficients of the display-side surface 26 of the second optical element 2 of the seventh embodiment in general formula (1).

Moreover, the relationship between each of the important parameters in the ocular optical system 10 of the seventh embodiment is as shown in FIG. 39 and FIG. 40.

FIG. 26A illustrates the longitudinal spherical aberration of the seventh embodiment, in which the imaging point deviation of off-axis rays at different heights is controlled within the range of ±0.05 mm. In the two field curvature aberration diagrams of FIG. 26B and FIG. 26C, the focal length variation amount of the three representative wavelengths in the entire field of view is within ±1.20 mm. The distortion aberration diagram of FIG. 26D shows that the distortion aberration of the present embodiment is maintained within the range of ±30%.

It may be known from the above description that the TTL of the seventh embodiment is shorter than the TTL of the first embodiment. Therefore, compared with the first embodiment, the eighth embodiment has a smaller volume. The image height of the seventh embodiment is larger than the image height of the first embodiment. Therefore, compared with the first embodiment, the seventh embodiment has better optical sensitivity. In addition, the longitudinal spherical aberration of the seventh embodiment is smaller than the longitudinal spherical aberration of the first embodiment.

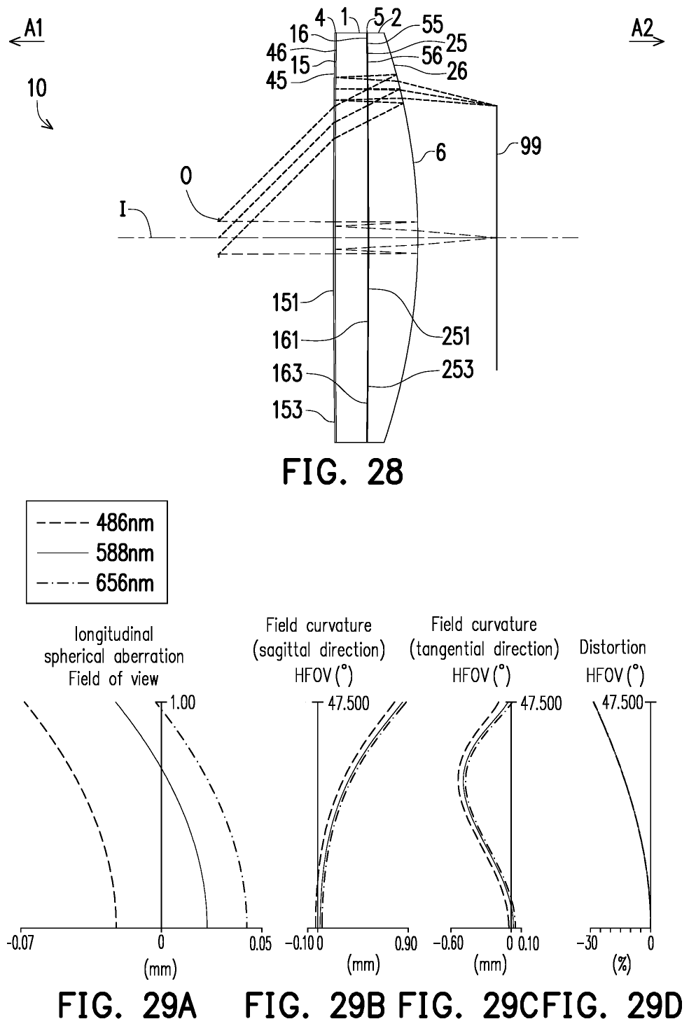

FIG. 28 is a schematic of the optical imaging lens of the eighth embodiment of the invention. FIG. 29A to FIG. 29D are diagrams of the longitudinal spherical aberration and various aberrations of the optical imaging lens of the eighth embodiment. Referring first to FIG. 28, the eighth embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the first optical element 1 has positive refracting power, the optical axis region 151 of the eye-side surface 15 of the first optical element 1 is convex, the periphery region 153 of the eye-side surface 15 of the first optical element 1 is convex, the optical axis region 161 of the display-side surface 16 of the first optical element 1 is convex, the periphery region 163 of the display-side surface 16 of the first optical element 1 is convex, the optical axis region 251 of the eye-side surface 25 of the second optical element 2 is convex, and the periphery region 253 of the eye-side surface 25 of the second optical element 2 is convex. In addition, the PV value of the eye-side surface 15 of the first optical element 1, the display-side surface 16 of the first optical element 1 and the eye-side surface 25 of the second optical element 2 is designed to be 156 μm. It should be mentioned here that, to clearly show the Figure, in FIG. 28, the reference numerals of the optical axis region and the periphery region similar to the surface shape in the first embodiment are omitted.

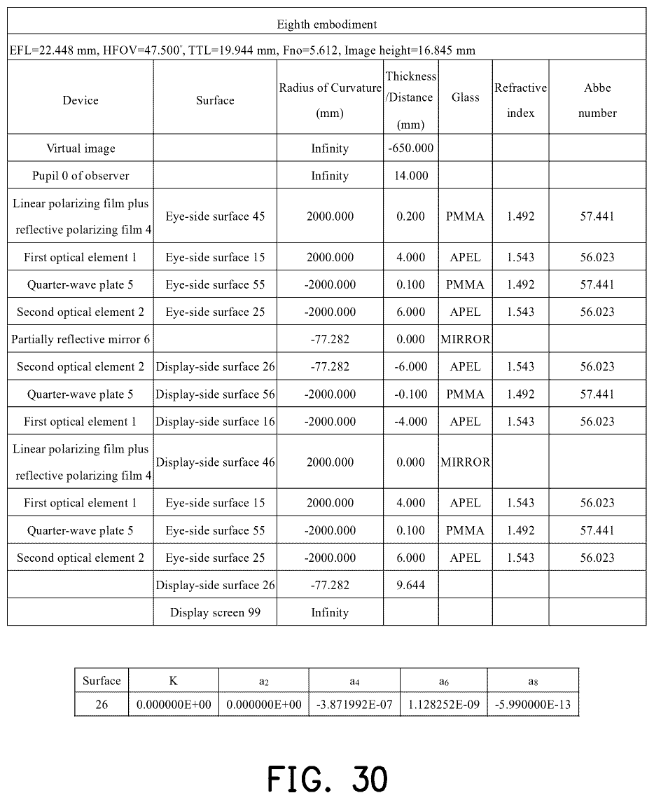

The detailed optical data of the ocular optical system 10 of the eighth embodiment is shown in FIG. 30, and the ocular optical system 10 of the eighth embodiment has an effective focal length of 22.448 mm, a half field of view of 47.500 degrees, a TTL of 19.944 mm, an f-number of 5.612, and an image height of 16.845 mm.

FIG. 30 also shows the aspheric coefficients of the display-side surface 26 of the second optical element 2 of the eighth embodiment in general formula (1).

Moreover, the relationship between each of the important parameters in the ocular optical system 10 of the eighth embodiment is as shown in FIG. 39 and FIG. 40.

FIG. 29A illustrates the longitudinal spherical aberration of the eighth embodiment, in which the imaging point deviation of off-axis rays at different heights is controlled within the range of ±0.07 mm. In the two field curvature aberration diagrams of FIG. 29B and FIG. 29C, the focal length variation amount of the three representative wavelengths in the entire field of view is within ±1.00 mm. The distortion aberration diagram of FIG. 29D shows that the distortion aberration of the present embodiment is maintained within the range of ±30%.

It may be known from the above description that the half field of view of the eighth embodiment is larger than the half field of view of the first embodiment. Therefore, compared with the first embodiment, the eighth embodiment has a larger angular range for receiving an image. The TTL of the eighth embodiment is shorter than the TTL of the first embodiment. Therefore, compared with the first embodiment, the eighth embodiment has a smaller volume. The aperture of the eighth embodiment is larger than the aperture of the first embodiment. Therefore, compared with the first embodiment, the eighth embodiment has a larger light influx. In addition, the longitudinal spherical aberration of the eighth embodiment is smaller than the longitudinal spherical aberration of the first embodiment.

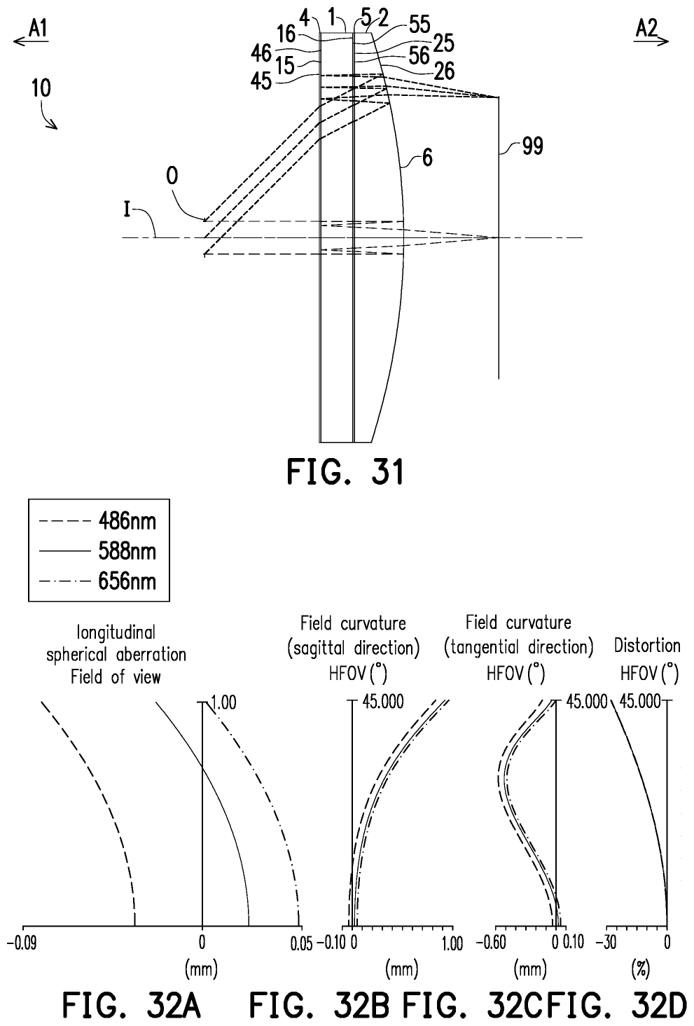

FIG. 31 is a schematic of the optical imaging lens of the ninth embodiment of the invention. FIG. 32A to FIG. 32D are diagrams of the longitudinal spherical aberration and various aberrations of the optical imaging lens of the ninth embodiment. Referring first to FIG. 31, the ninth embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the magnification of the ocular optical system 10 is increased to reduce observer fatigue under continuous use. It should be mentioned here that, to clearly show the Figure, in FIG. 31, the reference numerals of the optical axis region and the periphery region similar to the surface shape in the first embodiment are omitted.

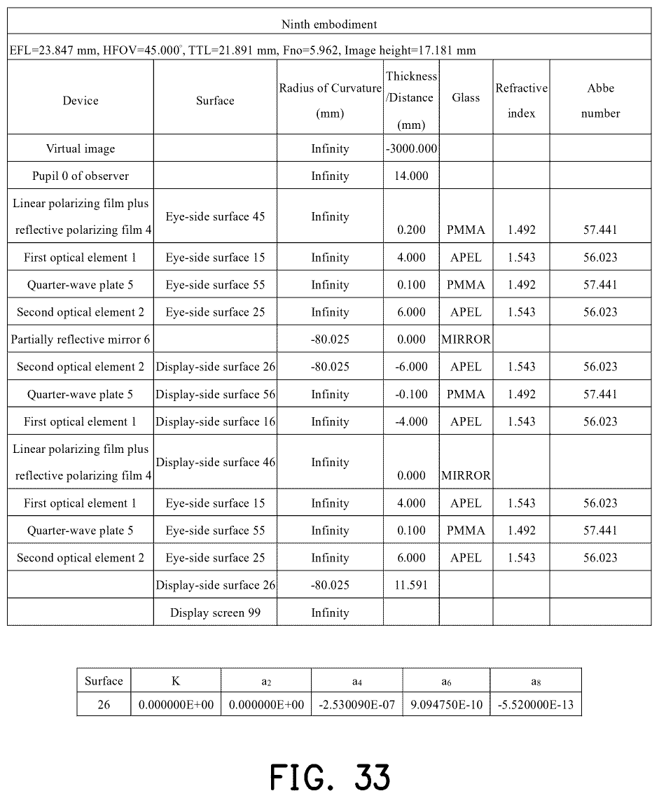

The detailed optical data of the ocular optical system 10 of the ninth embodiment is shown in FIG. 33, and the ocular optical system 10 of the ninth embodiment has an effective focal length of 23.847 mm, a half field of view of 45.000 degrees, a TTL of 21.891 mm, an f-number of 5.962, and an image height of 17.181 mm.

FIG. 33 also shows the aspheric coefficients of the display-side surface 26 of the second optical element 2 of the ninth embodiment in general formula (1).

Moreover, the relationship between each of the important parameters in the ocular optical system 10 of the ninth embodiment is as shown in FIG. 39 and FIG. 40.

FIG. 32A illustrates the longitudinal spherical aberration of the ninth embodiment, in which the imaging point deviation of off-axis rays at different heights is controlled within the range of ±0.09 mm. In the two field curvature aberration diagrams of FIG. 32B and FIG. 32C, the focal length variation amount of the three representative wavelengths in the entire field of view is within ±1.00 mm. The distortion aberration diagram of FIG. 32D shows that the distortion aberration of the present embodiment is maintained within the range of ±30%.

It may be known from the above description that the aperture of the ninth embodiment is larger than the aperture of the first embodiment. Therefore, compared with the first embodiment, the ninth embodiment has a larger light influx. In addition, the longitudinal spherical aberration of the ninth embodiment is smaller than the longitudinal spherical aberration of the first embodiment.

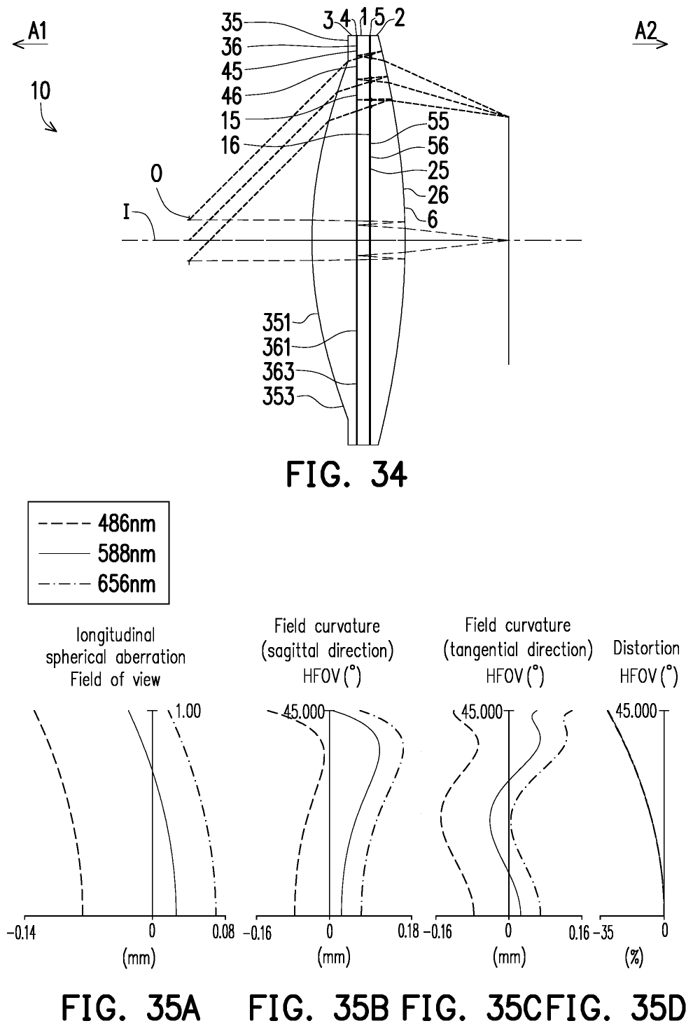

FIG. 34 is a schematic of the optical imaging lens of the tenth embodiment of the invention. FIG. 35A to FIG. 35D are diagrams of the longitudinal spherical aberration and various aberrations of the optical imaging lens of the tenth embodiment. Referring first to FIG. 34, the tenth embodiment of the ocular optical system 10 of the invention is substantially similar to the first embodiment, and the difference between the two is as follows: the optical data, the aspheric coefficients, and the parameters of the first optical element 1, the second optical element 2, the linear polarizing film plus reflective polarizing film 4 and the quarter-wave plate 5 are slightly different. Moreover, in the present embodiment, the third optical element 3 is added to help improve imaging quality such as MTF. It should be mentioned here that, to clearly show the Figure, in FIG. 34, the reference numerals of the optical axis region and the periphery region similar to the surface shape in the first embodiment are omitted.

The third optical element 3 has positive refracting power. An optical axis region 351 of the eye-side surface 35 of the third optical element 3 is convex, and a periphery region 353 thereof is convex. An optical axis region 361 of the display-side surface 36 of the third optical element 3 is flat, and a periphery region 363 thereof is flat.

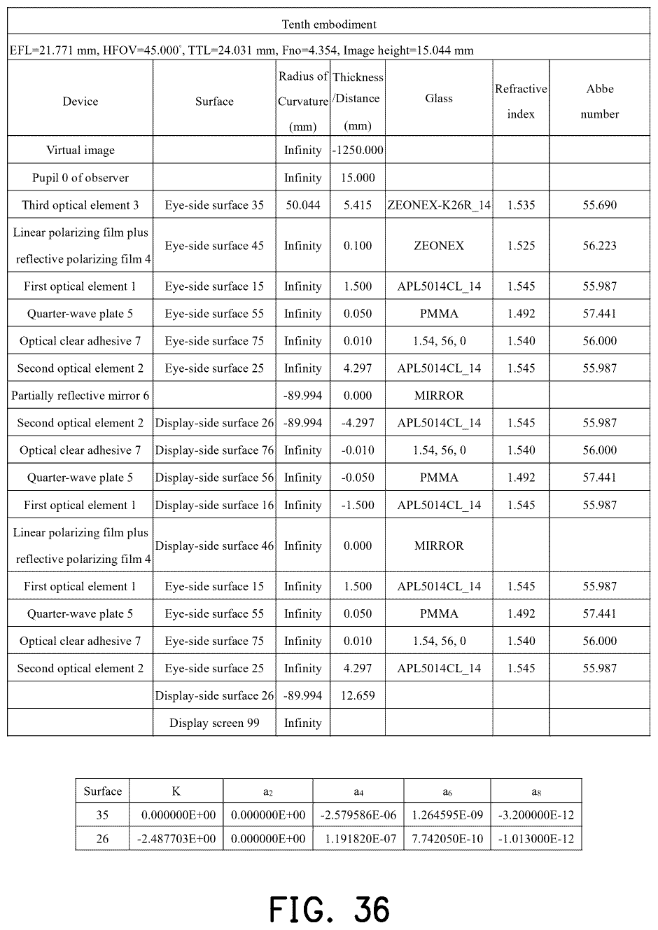

The detailed optical data of the ocular optical system 10 of the tenth embodiment is shown in FIG. 36, and the ocular optical system 10 of the tenth embodiment has an effective focal length of 21.771 mm, a half field of view of 45.000 degrees, a TTL of 24.031 mm, an f-number of 4.354, and an image height of 15.044 mm.

FIG. 36 also shows the aspheric coefficients of the display-side surface 26 of the second optical element 2 of the tenth embodiment in general formula (1).

Moreover, the relationship between each of the important parameters in the ocular optical system 10 of the tenth embodiment is as shown in FIG. 39 and FIG. 40.

FIG. 35A illustrates the longitudinal spherical aberration of the tenth embodiment, in which the imaging point deviation of off-axis rays at different heights is controlled within the range of ±0.14 mm. In the two field curvature aberration diagrams of FIG. 35B and FIG. 35C, the focal length variation amount of the three representative wavelengths in the entire field of view is within ±0.18 mm. The distortion aberration diagram of FIG. 35D shows that the distortion aberration of the present embodiment is maintained within the range of ±35%.

It may be known from the above description that the aperture of the tenth embodiment is larger than the aperture of the first embodiment. Therefore, compared with the first embodiment, the tenth embodiment has a larger light influx. In addition, the field curvature aberration of the tenth embodiment is smaller than the field curvature aberration of the first embodiment.

In the embodiments of the present invention, the eye-side surface 15 of the first optical element 1 and the display-side surface 16 of the first optical element 1 satisfy a conditional expression as follows: PV≤160 μm. Therefore, the ocular optical system 10 with double reflection optical effect is beneficial to reduce the thickness of the second optical element 2 that mainly provides refractive power. Since the time for plastic injection molding is proportional to the square of the element thickness, when the thickness of the second optical element 2 becomes thinner, the production cycle of the second optical element 2 can be shortened to increase product productivity and reduce manufacturing costs. Moreover, since the eye-side surface 15 of the first optical element 1 and display-side surface 16 of the first optical element 1 meet the PV≤160 μm, it will help reduce the difficulty of the film attaching process to improve yield and reduce manufacturing costs. In order to achieve better optical performance, the better limit of PV is PV≤5 μm.

The embodiments of the present invention further limit that there is no air gap between the display-side surface 16 of the first optical element 1 and the eye-side surface 25 of the second optical element 2, which is beneficial to mass production of the ocular optical system 10 and reduces manufacturing costs.

Since the distance between the eyes of the observer and the image of the ocular optical system 10 on the optical axis is proportional to the system length of the ocular optical system 10, the eye-side surface 15 of the first optical element 1 and the display-side surface 16 of the first optical element 1 satisfy PV≤160 μm. Therefore, it is beneficial for the ocular optical system 10 to satisfy the conditional expression 35≤|ObjD|/ImgH≤200, so as to improve the magnification (i.e. ObjH/ImgH) of the ocular optical system 10.

The embodiments of the present invention further limit the eye-side surface 25 of the second optical element 2 to satisfy PV≤160 μm, and there is no air gap between the display-side surface 16 of the first optical element 1 and the eye-side surface 25 of the second optical element 2. Therefore, it is beneficial to use an adhesive that matches the refractive index of the first optical element 1 and the refractive index of the second optical element 2 (Nd=1.492˜1.543), such as OCA (Optical clear adhesive) (Nd=1.540), to combine the second optical element 2 on the eye-side surface 15 of the first optical element 1. The purpose is to reduce the reflection when light enters OCA from second optical element 2 and enters the first optical element 1 from OCA to avoid ghosting. Furthermore, the above structure is conducive to mass production of the ocular optical system 10 and reduces manufacturing costs.

The first optical element 1 and the second optical element 2 are made of plastic or glass materials with low birefringence, such as APEL, PMMA or BK7, which can help to reduce the stress on the optical elements and thus reduce the chance of ghosting.

The first optical element 1 is a flat plate, which facilitates mass production of eyepiece optical systems, reduces the difficulty of the film attaching process and reduces manufacturing costs.

The second optical element 2 is a lens element, the eye-side surface 25 of the second optical element 2 is a flat, and the optical axis region 261 of the display-side surface 26 of the optical element 2 is a convex. Therefore, it is beneficial to improve the yield of injection molding of second optical element 2.

The linear polarizing film is disposed on the reflective polarizing film, and the anti-reflective film is disposed on the reflective polarizing film to help reduce stray light in the ocular optical system 10.

The embodiments of the present invention further limit 18≤|ObjD|/SL≤85, 30≤|ObjD|/TTL≤140 and 60≤|ObjD|/TL≤300. Therefore, the magnification of the ocular optical system 10 can be increased by increasing the distance and height of the image, so that the magnification meets 40≤ObjH/ImgH≤200.

The embodiments of the present invention further limit 1.6≤SL/ImgH≤2.8, 1.6≤ImgH/T1≤10.0 or 2.5≤ImgH/T2≤3.7. Therefore, reducing the image height can help increase the magnification of the ocular optical system 10 and reduce the size and weight of the display device.

The embodiments of the present invention further limit 2.5≤ER12/T1≤17.0, 3.0≤ER22/T2≤7.0, 2.0≤(ER11+ER21)/ALT≤10.0 or 1.5≤(ER21+ER22)/TTL≤3.0. Therefore, it is beneficial to reduce the ratio of the effective radius to the thickness of the optical element and improve the yield and productivity.

The suitable eye distance range of ocular optical system 10 is 5 to 20 mm. Further limiting 1.2≤ER/T1≤30.0 or 2.0≤ER/T2≤4.0 can help maintain a suitable eye distance between the ocular optical system 10 and the eye, making the observer less likely to fatigue.

The embodiments of the present invention further limit 2.0≤SL/TL≤6.0 or 1.4≤EFL/TL≤3.6. Therefore, it is beneficial to reduce the size and weight of the ocular optical system 10.

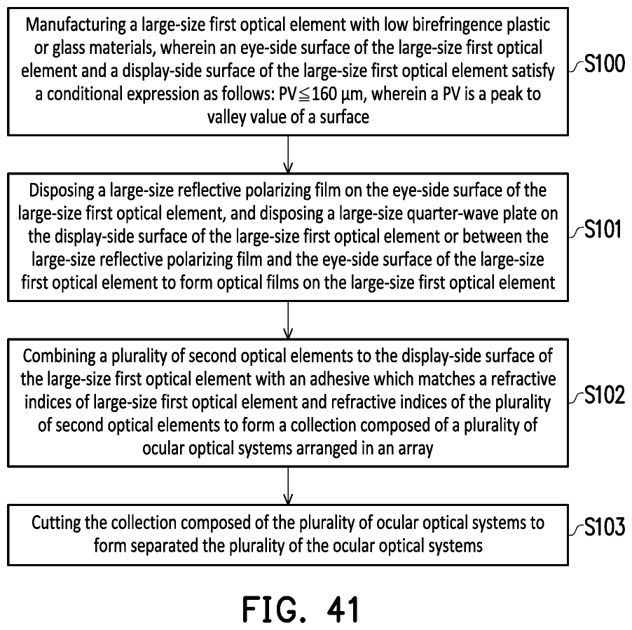

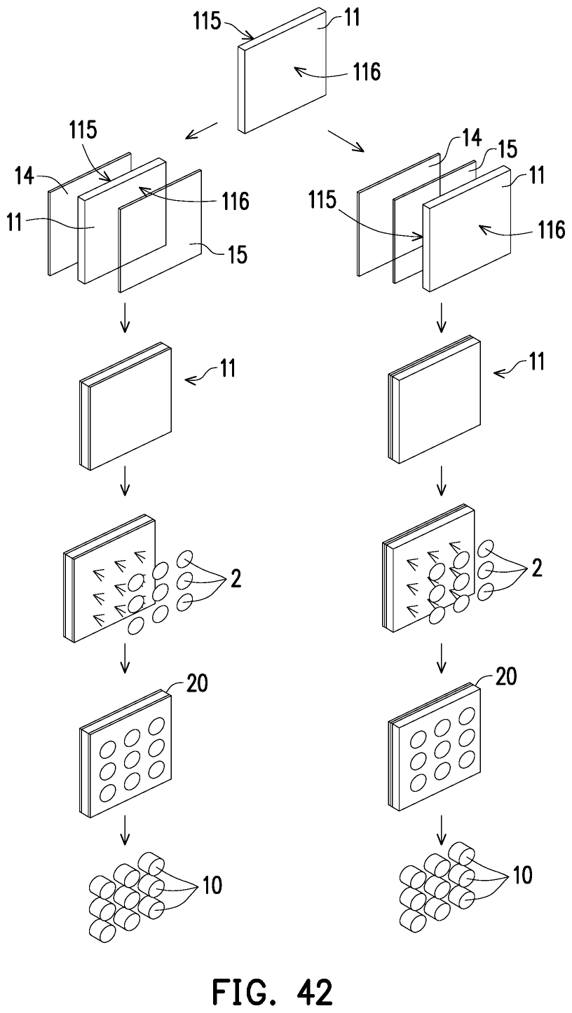

FIG. 41 is a step flow chart of a mass production manufacturing method of an ocular optical system. FIG. 42 is a schematic diagram of the mass production manufacturing method of the eyepiece optical system. Referring to FIG. 41 and FIG. 42. The step flow of the mass production manufacturing method of the ocular optical system shown in FIG. 41 can be applied to the ocular optical system 10 of at least the first embodiment to the tenth embodiments. In the embodiment, first, step S100 is performed to manufacture a large-size first optical element 11 with low birefringence plastic or glass materials, wherein an eye-side surface 115 of the large-size first optical element 11 and a display-side surface 116 of the large-size first optical element 11 satisfy a conditional expression as follows: PV≤160 μm, wherein a PV is a peak to valley value of a surface. Wherein the eye-side surface 115 of the large-size first optical element 11 and the display-side surface 116 of the large-size first optical element 11 are both flat. The above definition of large-size is, for example, the area is 21 cm×30 cm, but the present invention is not limited to this. In addition, in order to achieve better optical performance, the better limit of PV is PV≤5 μm.

Next, step S101 is performed to dispose a large-size reflective polarizing film 14 on the eye-side surface 115 of the large-size first optical element 11, and dispose a large-size quarter-wave plate 15 on the display-side surface 116 of the large-size first optical element 11 or between the large-size reflective polarizing film 14 and the eye-side surface 115 of the large-size first optical element 11 to form optical films on the large-size first optical element 11. In this way, the large-area coating of the ocular optical system 10 to be produced can be completed at one time.

Next, step S102 is performed to combine a plurality of second optical elements 2, for example, made by injection molding, to the display-side surface 116 of the large-size first optical element 11 with an adhesive which matches a refractive indices of large-size first optical element 11 and refractive indices of the plurality of second optical elements 2 to form a collection 20 composed of a plurality of ocular optical systems 10 arranged in an array. In this way, the material waste can be minimized.

Next, step S102 is performed to cut the collection 20 composed of the plurality of ocular optical systems 10 to form separated the plurality of the ocular optical systems 10. In this way, production efficiency can be improved to reduce manufacturing costs.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤B≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments. The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

What is claimed is:

1. An ocular optical system, configured to allow imaging rays from a display screen to enter an eye of an observer through the ocular optical system to form an image, wherein a side toward the eye is an eye-side, and a side toward the display screen is a display-side, the ocular optical system comprises a first optical element and a second optical element sequentially arranged along an optical axis from the eye-side to the display-side, each of the first optical element and the second optical element comprising an eye-side surface facing the eye-side and allowing the imaging rays to pass through and a display-side surface facing the display-side and allowing the imaging rays to pass through, the ocular optical system also comprises a reflective polarizing film and a quarter-wave plate;
the eye-side surface of the first optical element and the display-side surface of the first optical element satisfy a conditional expression as follows:
PV≤160 μm, wherein a PV is a peak to valley value of a surface;
the reflective polarizing film is disposed on the eye-side of the first optical element;
the quarter-wave plate is disposed on the display-side of the first optical element or between the reflective polarizing film and the eye-side of the first optical element;
wherein the ocular optical system satisfy a conditional expression as follows:
35≤|ObjD|/ImgH≤200, wherein ObjD is a distance from the eye of the observer to the image formed by the ocular optical system on the optical axis, and ImgH is a maximum image height of the ocular optical system.

2. The ocular optical system according to claim 1, wherein a linear polarizing film is disposed on the reflective polarizing film, and an anti-reflective film is disposed on the reflective polarizing film.

3. The ocular optical system according to claim 1, wherein the eye-side surface of the first optical element and the display-side surface of the first optical element satisfy a conditional expression as follows: PV≤5 μm.

4. The ocular optical system according to claim 1, wherein the ocular optical system further satisfies a conditional expression as follows: 60≤|ObjD|/ImgH≤200.

5. The ocular optical system according to claim 1, wherein the ocular optical system further satisfies a conditional expression as follows: 18≤|ObjD|/SL≤85, wherein SL is a distance from the eye of the observer to the display screen on the optical axis.

6. The ocular optical system according to claim 1, wherein the ocular optical system further satisfies a conditional expression as follows: 1.6≤SL/ImgH≤2.8, wherein SL is a distance from the eye of the observer to the display screen on the optical axis.

7. The ocular optical system according to claim 1, wherein the ocular optical system further satisfies a conditional expression as follows: 2.5≤ER12/T1≤17.0, wherein ER12 is a maximum distance from a center of the display-side surface of the first optical element to a mounting portion, and T1 is a thickness of the first optical element on the optical axis.

8. The ocular optical system according to claim 1, wherein the ocular optical system further satisfies a conditional expression as follows: 2.0≤(ER11+ER21)/ALT≤10.0, wherein ER11 is a maximum distance from a center of the eye-side surface of the first optical element to a mounting portion, ER21 is a maximum distance from a center of the eye-side surface of the second optical element to a mounting portion, and ALT is a sum of thicknesses of the first optical element and the second optical element on the optical axis.

9. The ocular optical system according to claim 1, wherein the ocular optical system further satisfies a conditional expression as follows: 1.2≤ER/T1≤30.0, wherein ER is a distance from the eye of the observer to the first optical element on the optical axis.

10. The ocular optical system according to claim 1, wherein the ocular optical system further satisfies a conditional expression as follows: 2.0≤SL/TL≤6.0, wherein SL is a distance from the eye of the observer to the display screen on the optical axis, and TL is a distance from the eye-side surface of the optical element closest to the eye-side to the display-side surface of the second optical element on the optical axis.

11. An ocular optical system, configured to allow imaging rays from a display screen to enter an eye of an observer through the ocular optical system to form an image, wherein a side toward the eye is an eye-side, and a side toward the display screen is a display-side, the ocular optical system comprises a first optical element and a second optical element sequentially arranged along an optical axis from the eye-side to the display-side, each of the first optical element and the second optical element comprising an eye-side surface facing the eye-side and allowing the imaging rays to pass through and a display-side surface facing the display-side and allowing the imaging rays to pass through, the ocular optical system also comprises a reflective polarizing film and a quarter-wave plate;
the eye-side surface of the first optical element, the display-side surface of the first optical element and the eye-side surface of the second optical element satisfy a conditional expression as follows:
PV≤160 μm, wherein a PV is a peak to valley value of a surface;
the reflective polarizing film is disposed on the eye-side of the first optical element;
the quarter-wave plate is disposed on the display-side of the first optical element or between the reflective polarizing film and the eye-side of the first optical element; and
there is no air gap between the display-side surface of the first optical element and the eye-side surface of the second optical element.

12. The ocular optical system according to claim 11, wherein the display-side surface of the second optical element is convex.

13. The ocular optical system according to claim 11, wherein the ocular optical system further satisfies a conditional expression as follows: 30≤|ObjD|/TTL≤140, wherein TTL is a distance from the eye-side surface of the optical element closest to the eye-side to the display screen on the optical axis.

14. The ocular optical system according to claim 11, wherein the ocular optical system further satisfies a conditional expression as follows: 60≤|ObjD|/TL≤300, wherein TL is a distance from the eye-side surface of the optical element closest to the eye-side to the display-side surface of the second optical element on the optical axis.

15. The ocular optical system according to claim 11, wherein the ocular optical system further satisfies a conditional expression as follows: 2.5≤ImgH/T2≤3.7, wherein T2 is a thickness of the second optical element on the optical axis.

16. The ocular optical system according to claim 11, wherein the ocular optical system further satisfies a conditional expression as follows: 3.0≤ER22/T2≤7.0, wherein ER22 is a maximum distance from a center of the display-side surface of the second optical element to a mounting portion, and T2 is a thickness of the second optical element on the optical axis.

17. The ocular optical system according to claim 11, wherein the ocular optical system further satisfies a conditional expression as follows: 1.5≤(ER21+ER22)/TTL≤3.0, wherein ER21 is a maximum distance from a center of the eye-side surface of the second optical element to a mounting portion, ER22 is a maximum distance from a center of the display-side surface of the second optical element to a mounting portion, and TTL is a distance from the eye-side surface of the optical element closest to the eye-side to the display screen on the optical axis.

18. The ocular optical system according to claim 11, wherein the ocular optical system further satisfies a conditional expression as follows: 2.0≤ER/T2≤4.0, wherein ER is a distance from the eye of the observer to the first optical element on the optical axis, and T2 is a thickness of the second optical element on the optical axis.

19. The ocular optical system according to claim 11, wherein the ocular optical system further satisfies a conditional expression as follows: 1.4≤EFL/TL≤3.6, wherein EFL is an effective focal length of the ocular optical system, and TL is a distance from the eye-side surface of the optical element closest to the eye-side to the display-side surface of the second optical element on the optical axis.

20. A mass production manufacturing method of an ocular optical system, comprising:
Manufacturing a large-size first optical element with low birefringence plastic or glass materials, wherein an eye-side surface of the large-size first optical element and a display-side surface of the large-size first optical element satisfy a conditional expression as follows: PV≤160 μm, wherein a PV is a peak to valley value of a surface;
Disposing a large-size reflective polarizing film on the display-side surface of the large-size first optical element, and disposing a large-size quarter-wave plate on the display-side surface of the large-size first optical element or between the large-size reflective polarizing film and the display-side surface of the large-size first optical element to form optical films on the large-size first optical element;
Combining a plurality of second optical elements to the display-side surface of the large-size first optical element with an adhesive which matches a refractive indices of large-size first optical element and refractive indices of the plurality of second optical elements to form a collection composed of a plurality of ocular optical systems arranged in an array; and
Cutting the collection composed of the plurality of ocular optical systems to form separated the plurality of the ocular optical systems.
